(19) United States
(12) Patent Application Publication
(10) Pub. No.: US 2013/0052014 A1
(43) Pub. Date: Feb. 28, 2013

(54) SPINNAKER SAILS FROM INTERWOVEN STRAPS FOR GENERATING ELECTRIC POWER FROM WIND

(71) Applicant: Patrick D. Kelly, Kirkwood, MO (US)

(72) Inventor: Patrick D. Kelly, Kirkwood, MO (US)

(21) Appl. No.: 13/218,445

(22) Filed: Aug. 25, 2011

(51) Int. Cl. F03D 5/00

(52) U.S. Cl. 416/66

(57) ABSTRACT

New types of “airborne spinnaker sails” are disclosed, made from high-strength straps that are interwoven in a manner that preserves open space between them. These devices, referred to as “webbing sails” or simply “web sails”, are designed for use in conjunction with buoyant lifting devices, to capture and harvest wind energy in a way which will generate large mechanical pulling forces, which can be used to drive electric power generators. These types of web sails are designed to operate in winds that exceed 100 or even 150 miles per hour.

### BACKGROUND

This invention is in the field of electromechanical systems, and relates to the use of specialized types of spinnaker sails, to convert wind energy into electric power.

This application involves a new type of “airborne spinnaker sail”, which will function as a component or subassembly within a larger electromechanical system which has been described in U.S. patent application Ser. No. 12/390,503, which was published on Aug. 26, 2010 as 20100213718. All teachings and disclosures set forth in that application are incorporated herein, as though fully set forth herein.

In addition, this application is being filed simultaneously with a continuation-in-part application which claims the benefit and priority date of U.S. Ser. No. 12/390,503. That C-I-P application has been given Ser. No. 13/217,873, and its entire teachings and contents are incorporated by reference, as though fully set forth herein. It was designated as a C-I-P application, since its teachings and claims overlap substantially with the teachings in the '503 parent application.

By contrast, the new type of airborne spinnaker sail disclosed herein is a separate and distinct “offshoot” of the technology described in the '503 application. It is independently patentable in its own right, since nothing in the '503 application disclosed or suggested, in any way, these new types of spinnaker sails. Accordingly, this is an original application, with no claim to any priority date earlier than the Aug. 25, 2011 filing date of this application.

The system described in the published '503 application was published less than a year prior to the filing date of this application; accordingly, this current application is being filed within the post-publication “grace period” set forth in the US patent law, in 35 USC 102. Nevertheless, it is convenient to treat the previously-disclosed system as a foundation or “baseline” of information, and then focus on the new and additional developments that are disclosed herein for the first time.

Briefly, the disclosures in parent application Ser. No. 12/390,503 describe a system as depicted in FIGS. 1 and 2. FIG. 1 depicts the system during an “ascent stage” of a “power cycle”. During that stage, train cars 100 loaded with large, heavy, and powerful electric generators 110 are being pulled, by cable 115, to the top of a rail track 120 that has been installed on the side of a large hill or small mountain. For purposes of scale, it can be assumed that the train and generators (combined) weigh at least 100 tons, and the amount of vertical ascent is at least 500 feet.

The mechanism that will use wind power to pull the train and generators to the top of the track is created by a combination of: (i) a hydrogen- and/or helium-filled blimp or zeppelin 200; and, (ii) a spinnaker sail 300, tethered to the blimp 200.

The blimp or zeppelin 200 was initially described in U.S. Ser. No. 12/390,503, published in August 2010. After a Notice of Allowance was received for that application, when the applicant/inventor herein (who is both a licensed professional engineer, and a patent attorney) reviewed the application in some detail, to determine whether to have it issue as a patent or to supersede it with an expanded and updated application, it was realized that the rail track and train-with-generators system can be completely eliminated, thereby reducing the overall cost of the system, if the blimp-and-sail pulling system is directly coupled, via a cable, to an enlarged drum or spool mounted on the rotating shaft of an electric generator. Accordingly, the C-I-P application mentioned above (U.S. Ser. No. 13/217,873) was intended mainly to address that modified type of system. Then, once the applicant herein began to seriously wrestle with how that system could be improved and enhanced, various other potential improvements also began to be recognized, including a new design for “webbing sails” that can operate in very high or even extremely high wind speeds. Those types of webbing sails (or simply “web sails”, for convenience) are the subject of the invention herein.

FIGS. 3-5, which are prior art, were used to clearly set forth several major inefficiencies, shortcomings, and limitations in conventional 3-blade wind turbines. They are explained in detail in simultaneously-filed application Ser. No. 13/217,873 (which will be published well before this current application), by the same applicant/inventor herein. It is not necessary to fully understand those drawings, to understand the webbing sails that are disclosed and claimed herein. Therefore, this application will not repeat the detailed discussion of FIGS. 3-5, which can be found in the '873 application.

The specific problem which is addressed by this current invention is that wind speeds at elevated altitudes are usually substantially higher than winds at ground level, and often exceed 100 or even 150 miles per hour, depending on location, altitude, and weather conditions. Wind speeds that high would rapidly rip apart any conventional spinnaker sail of the type used on a sailboat. Therefore, the Applicant herein realized that in order to help establish airbarge-and-sail installations as viable and practical power-generating systems that can operate even at extremely high wind speeds that can occur at elevated altitudes, new and different types of airborne spinnaker sails need to be created and developed, which can withstand wind speeds of over 100 or even 150 miles per hour without suffering any damage or degradation, and which can provide the operators of wind-to-electricity installations with practical and usable devices that can indeed be used to generate electric power, even in extremely high winds.

Before addressing how such sails can be created, some introductory information on conventional sails and sailcloth, and on conventional spinnaker sails as used on sailboats, is appropriate, and should be understood by anyone interested in this invention.

### TERMINOLOGY RE: CABLES, STRAPS, AND SAILS

Several relevant terms need to be addressed and defined, especially since some of these terms are used inconsistently, in the art.

The terms tether, cable, and line are used interchangeably herein, to refer to “tensile members” (i.e., items which are designed to withstand pulling forces) which: (i) are used to connect or couple two different items together; and, (ii) have sufficient flexibility to be handled by winches, pulleys, and similar devices, and which can be wound around and stored on spools, drums, etc. The requirement for flexibility eliminates various types of bars, struts, and other stiff or rigid members, which can act as “tensile members” in various types of structures.

The term “rope” is avoided herein, since it tends to imply natural fibers, in the minds of many readers. Even though ropes made of natural fibers could be used as described herein, they will degrade much more rapidly, when used outdoors, than cables made of synthetic materials suited for outdoor use.

In some situations, a chain can be used to create a “single-point tether” (i.e., the type of tethering attachment in which a single cable, strap, or other flexible tensile member passes between two different items, and couples the two items to each other; these are different from the type of attachment that is created when the edge of a sail is coupled to a mast, beam, or other structural component, by means of multiple loops of rope or cable, or by using a sliding mechanism in which multiple attachment points travel up or down a mast while constrained within a vertical slot in the mast). Because of their added weight and expense, and because of the risks of rust and other problems, chains are not used on boats and aircraft except for specific purposes, such as to provide additional weight for an anchor, or to provide a tensile member which will interact with a gear or sprocket in a manner which reliably prevents any slipping or sliding motions, and which eliminates abrasion and gradual deterioration.

The cross-sectional shapes of various types of tensile members is also important, and requires attention. The terms “strap” or “belt” are used interchangeably herein, to refer to any flexible tensile member that has been created in a manner which provides it with substantial additional width, compared to a cable having the same cross-sectional area (and strength), but with a round cross-section. The additional width and surface area provided by a strap, compared to a round cable, can enable a gripping mechanism to generate a stronger and more stable grip, and more secure control over movement along the length of the strap. In addition, when a strap is wrapped around or over something which needs to be secured and held tightly, the extra width of the strap can help distribute and “spread out” the forces and stresses imposed on the item(s) being secured, in ways that are less likely to damage the items that are being secured. Therefore, flattened straps are used much more commonly than round ropes or cables, in most industrial, commercial, and cargo-handling environments.

The term “nylon webbing” has become a standard industry term which refers to straps made from woven or braided nylon fibers. Dozens of illustrated examples (which are available for sale, from numerous suppliers) can be quickly located, by searching any internet search engine for “nylon webbing”. However, because a completely different type of “nylon webbing” is of interest herein (involving wide nets that cover large areas, created by weaving and stitching together numerous straps in a controlled configuration, as discussed below), the terms “webbing” or “nylon webbing” are not used herein to refer to a single strap, regardless of how wide it is. Instead, the term “strap” refers to any tensile member with a cross-section that is substantially wider and flatter than a round rope or strap having the same cross-sectional area.

There is a hypothetical intermediate or transitional zone where “slightly elliptical or oval” straps could be created, which might raise questions as to whether they should be called round cables, or flat straps. However, in essentially all cases of interest herein, where high levels of strength will be required, the strap widths of interest normally will be at least about 1.5 inches (nearly 4 cm), and strap widths of at least about 2 to about 6 inches (5 to 15 cm) will generally be preferred for most cases. Accordingly, an alternate definition of “strap” which can be used herein is limited to straps having a width (as distinct from thickness, the smaller cross-sectional dimension) of at least 1 inch or greater.

Any use herein of the term “about” is intended to imply a significant but not excessive amount of leeway, and a benchmark quantity equal to 10% (ten percent) can be used unless a particular context clearly indicates otherwise. Accordingly, if a term refers to a strap width of “at least about 1 inch”, then a strap with a 0.9 inch width would qualify, and if a term refers to a strap width of “at least about 2 inches”, then a strap width of 1.8 inches would qualify.

The term “sail”, as used herein, refers to a segment or assembly of fabric (or a similar layer of relatively thin and flexible material, as described below) which is designed to create horizontal force, when operated upon by wind, that will be imparted to a movable object (such as a boat, vehicle, or airborne device as described herein), to help move the object. A sail can contain and include various additional components (such as reinforcing straps, attachment devices, etc.); it can be made of or coated by a polymer or any other suitable compound; and, it can be either permeable or impermeable to air and wind, so long as it is designed and used to impart wind-driven horizontal force to a movable object. The force it imparts to the movable object does not need to be entirely or strictly horizontal, so long as the horizontal component of the force it creates, when operated upon by wind, is large enough to provide a practical and usable level of force that will help move the object.

For convenience, the term “fabric” is used herein, to refer to any relatively thin and flexible material which is used to create a sail as defined herein (the term “sheet” could also be used; however, it has a different, conflicting, and possibly confusing meaning in nautical terminology, to refer to ropes or cables which pull things in horizontal rather than vertical directions). In conventional sailboats, a single layer of woven fabric is normally used to form a sail, which will include various types of straps, hems, grommets, and similar devices by the time it is ready for sale and/or use. Any such devices usually are regarded as part of a sail, and are included in the definition of “sail”.

Because of their much greater strength and durability, sails made from synthetic polymers replaced natural fiber sails about 40 years ago, and essentially no sails are still being made from natural fibers, in any industrialized countries. The Wikipedia entry entitled “Sailcloth” provides a good introduction to the types of synthetic fibers and fabrics that are used to make sails.

One of the factors worth noting, in that Wikipedia entry, can be summarized as follows. The types of polymer fibers used to make sails can be divided into “standard” and “high-performance” categories. “Standard” polymers includes DACRON (a trademarked name for polyethylene terephthalate) and PENTEX (a trademarked name for polyethylene napthalate). “High-performance” polymers are sold under trademarks such as KEVLAR, TECHNORA, and TWARON (polyaramids) and SPECTRA (ultra-high-molecular-weight polyethylene, abbreviated as UHMWPE).

The basic difference between those two categories is that “standard” fibers such as DACRON or PENTEX, which are less expensive, tend to stretch more. That type of stretching leads to a type of “energy drain”, since sails made from stretchable fibers will act in a manner comparable to springs. Wind energy that presses against a “stretchable” sail will be dissipated and wasted, to some extent, by cyclic and repetitive actions that involve slightly stretching the sails, during gusts of wind, and then allowing the sails to return to a more relaxed state, between gusts. By contrast, sails made from “high-performance” polymers such as KEVLAR or UHMWPE stretch very little, even during the strongest gusts. This allows the additional energy of each gust to be transferred to the boat itself, to drive it forward faster, rather than being dissipated by stretching the sails.

A second factor worth noting is that KEVLAR (the most common recognized name for the super-strong materials made from polyaramid (or simply “aramid”) compounds) is no longer the only name for such fibers. Aramid materials, and devices such as bulletproof vests made from aramid fibers, have been available for more than 40 years. Their basic patents expired decades ago, and aramid fibers, straps, and fabrics are now sold at competitive prices by multiple suppliers. On a per-weight basis, aramid materials have about 5 times the strength of steel, and they can be used to make extraordinarily strong cables, straps, belts, sheets, and similar devices. Therefore, they will merit careful evaluation, for use in airborne spinnaker sails.

It also should be noted that any polymer of interest which has been commercialized will have various different formulations and types. As just one example, there are six major variants of commercially available nylon, which are identified within the industry by phrases such as nylon-6, nylon-6,6, nylon-4,6, etc. In general, nylon-4,6 is regarded as “industrial strength” nylon, since it has greater tensile strength and less stretchability than nylon-6 or nylon-6,6, which are the two variants most commonly found in clothing, carpets, and residential settings. Any company which sells these types of polymeric fibers will have technically-oriented salespeople who will be familiar with the major variants of any polymer sold by that company, and by its competitors. Therefore, anyone interested in any class or type of polymer for use as described herein should consult with several such vendors, to identify those variants of any specific polymers that are likely to render the best, most cost-effective service and results, when used as described herein.

Most sails that are used on sailboats either: (i) do not use any particular type of network of reinforcing straps, to help strengthen such sails; or, (ii) are made from two or three segments of material, which overlap with each other and which are folded and sewn together in a way which effectively creates a multi-layer seam or hem which will function in a manner comparable to a reinforcing strap.

However, because of the large forces that are involved in driving generators that will create electric power at utility scales, and because of the high winds that occur at elevated altitudes, any “airborne spinnaker sail” that will be of interest herein will require some type of array (which can also be called a network, net, web, matrix, or similar terms) of reinforcing straps to be distributed around the area of the sail. In square or rectangular sails, the array can include a square or rectangular “weave” of reinforcing straps; in a round or elliptical parachute, the straps can combine “radial” and “concentric” (or “annular”) arrangements.

To provide greater strength and security, any reinforcing straps typically will be positioned on the “back” side of a sail (i.e., the side which wind will not blow against; it can also be called the downwind, leeward, or non-facing side, or similar terms), so that the wind will press the fabric against the straps, rather than attempting to pull and pry the fabric away from reinforcing straps that are positioned on the upwind (or facing, windward, etc.) side of a sail.

If desired, “laminated” sails can be created, having two or more layers of material bonded to each other. In nearly all such cases, laminated sails are created by coating a polymeric “film” (which usually is impermeable to water or air) onto a surface of a woven fabric. Any fabric made from woven or knitted fibers will inevitably have some degree of permeability, to air and wind; however, since “tight weaves” are used to make sailcloth, and since the types of fibers used to make sailcloth tend to be “fluffy” when seen under a microscope, in a manner which enables them to create nearly airtight seals between adjacent strands, permeability to air flow, in any conventional sailcloth material, is very low, and close to negligible. Accordingly, laminated sails coated with impermeable films are of interest mainly among racing enthusiasts, and the amount of “pull” which can be generated by a coated and laminated sail is only marginally higher than the amount of “pull” generated by an equivalent non-laminated sail.

Finally, to complete the definitions of “sail” and “fabric” as used herein, it should be pointed out that at least some airborne spinnaker sails that are intended for use at elevated altitudes, where wind speeds often exceed 100 or even 150 miles per hour, will need to have a different design and structure than typical sails used on sailboats. Accordingly, as described below, extremely strong sails designed to capture wind energy, for electric power generation, can be made entirely of webbings made from interwoven straps, which can have various fractions or percentages of “open space” that are deliberately incorporated into the sail material, as illustrated in FIGS. 20 and 21. Such sheets made from flexible interwoven straps fall within the definition of “fabric” as set forth above, and sails made from such materials fall within the definition of “sail”.

### Spinnaker Sails

For any reader who may not have a working familiarity with the design and operating principles of “spinnaker sails”, searches using Internet sources such as Wikipedia and Google can quickly provide good illustrated introductions. In addition, an excellent glossary of sailing and other nautical terms is available, at no charge, at www.seatalk.info.

As a brief overview, in the realm of sailboats and nautical terms, spinnaker sails are not affixed to a mast or other rigid support, along one edge of the sail. Instead, the tethers which are used to deploy (i.e., bring out of storage, and move into position for active use), trim (adjust), and furl (retract and return to storage, when appropriate) a spinnaker sail fall into a category that can be referred to as “single-point tethers”. These types of attachments, which can be created by using a single cable, strap, or other flexible tensile member to couple two different items to each other, are different from the type of attachment that is created when the edge of a sail is coupled to a mast, beam, or other structural component, by means of multiple loops of rope or cable, or by using a sliding mechanism in which multiple attachment points travel up or down a mast while constrained within a vertical slot in the mast.

When a spinnaker sail is in use, one end of each tethering cable is attached to a corner of the spinnaker (usually by passing the cable through a reinforced “grommet”, which will pass through a strong reinforcing strap), while the other end of the cable normally is attached to a winch. Except on small boats which use only small spinnakers, winches usually are necessary, so that a long handle (or powered gear) which rotates a small spool can provide the amounts of leverage and force that are needed to handle a large sail that can generate very high levels of force and tension.

Because each attachment point on a spinnaker sail typically requires its own dedicated winch, and since each winch typically requires one or more people or motors to operate it whenever any changes or adjustment are made, a minimum number of attachment points typically are used to secure a spinnaker sail. Since a spinnaker sail has only a minimal number of tethering cables (usually three, as mentioned below), it takes a distinctly rounded shape when in use, and generally looks like a cross between an inflated ball and an overstuffed pillow.

Typically, a single upper attachment point is used, to establish and control the height of the spinnaker. Two lower attachment lines, spaced apart from each other (usually controlled by winches mounted on opposite sides of a boat) are used, to provide lateral (horizontal) control and “trim”. The word “trim” generally refers to the steps that are taken to adjust the horizontal angles and orientations of any and all sails, at any point in time while a sailboat is sailing, to optimize the orientation of the sails with respect to both (i) the direction of the boat, and (ii) the direction of the wind, at any moment in time.

The winches which are used to control the cables that attach a spinnaker sail to a boat have three main functions: (1) they release (“unfurl”) the spinnaker sail in a gradual and controlled manner, so that it does “snap” into place in a manner that would impose violent and potentially destructive hammering-type stresses on the rigging or the boat; (ii) they are used to adjust and “trim” the spinnaker sail, during use, to make optimal use of the wind; and (iii) they retract the spinnaker sail, when appropriate. Even when winches are available, sailors who are not in the middle of a race typically will turn a boat crossways to the wind, when the time arrives to retract a spinnaker, to minimize the tensile forces on the cables and winches while the spinnaker is being retracted and “furled”.

Spinnakers are useful only when a boat is traveling downwind (i.e., in the same direction as the wind). Because spinnaker sails can generate so much power and pulling force, an angled variance of only up to about 20 degrees (away from the wind direction) will be tolerated by most sailors, since a strong gust could capsize the boat if it is traveling at a greater “crossways” angle with respect to the wind.

To avoid interference or entanglements with masts, sails, lines, etc., a spinnaker sail will almost always be deployed at the farthest possible forward end of the boat (i.e., the bow, nose, etc.), well in front of any other sails or lines. In many cases, a spinnaker will be positioned entirely out over the water while in use, beyond the forward-most tip of the boat hull.

It also should be noted that if a spinnaker sail is deployed with a vertical slant (by allowing the two lower attachment cables to be released and extended a controlled amount), it can generate vertical lift for a boat, which can generate even faster speeds, due to a “hydroplaning” effect that occurs if the forward part of a boat hull is lifted partially out of the water.

When the concepts and mechanisms of spinnaker sails, on sailboats, are moved over to a very different setting, to create parachute-type sails that will be held up hundreds of feet (or dozens or hundreds of meters) in the sky to help generate electric power from wind energy, three important points become apparent, and all three of these points support the assertion that spinnaker sails can be used to create power-generating mechanisms which can be much more efficient than wind turbines.

First: unlike a conventional wind turbine, which has three long, narrow blades that which occupy only about 5 percent of the swept area, while allowing the wind to blow freely, untouched, and unused through the remaining 95 percent of the swept area, a spinnaker sail can effectively capture the entire force and power of the wind, applied across the entire “projected area” (discussed below) of the sail. As a result, a spinnaker sail would appear to be an ideal mechanism for capturing and harvesting as much tensile force and pulling power as possible, from wind energy.

Second: as mentioned above, and as illustrated in FIG. 4, the fan blades of a wind turbine suffer from a 90-degree misalignment between the power source (i.e., the direction of the wind), and the power-harvesting mechanism (i.e., the angled surface of a fan blade). By contrast, if a spinnaker sail is attached to a buoyant aircraft to help drive a power generator, the spinnaker sail will align itself directly with the wind. If the local wind, at an elevated height where a buoyant aircraft and spinnaker sail are flying, begins to blow at an angle of 13.2 degrees south of a direct west-to-east pathway, at some particular minute on some particular day, the spinnaker sail will immediately go to the exact angled direction where the wind pulls it the hardest. As a result, a spinnaker sail would appear to have an ideal design for capturing as much tensile force and pulling power as possible, from wind energy.

Third: unlike a conventional wind turbine, which has a zero-torque zone at the very center and a low-torque zone which surrounds that center, both of which act as “unproductive overhead”, a spinnaker sail uses its entire “projected area” in an efficient manner, with no “dead weight” or “unproductive overhead”, to generate very high levels of pulling and tensile force, which can be used to forcibly drive the rotating shaft of an electric generator.

For all three reasons, spinnaker sails appear to offer an ideal mechanism for capturing and harvesting mechanical energy, from wind energy. When all three of the factors listed above are taken into account, if a spinnaker sail has the same “projected area” as the “swept area” of a conventional 3-blade wind turbine, the spinnaker sail has the potential to generate usable mechanical power which may be a large multiple of the amount of usable force and power that can be generated by the wind turbine. While the exact amount of the power increase offered by spinnaker sails, compared to 3-blade wind turbines (i.e., the quantity of force and power which can be used to rotate the shaft of an electric power generator), is not known to the Applicant herein as this is being written and filed, it likely is already known to researchers who work full-time in this field, and it is estimated by the Applicant herein (who is a licensed professional engineer, as well as a patent attorney) to be at least 10-fold greater, and may be up to 40-fold or even 50-fold greater.

The term “projected area” (of a spinnaker sail) was mentioned above, and it requires attention. It effectively refers to what mathematicians call a “planar projection” (where the terms “plane” and “planar” refer to a large imaginary flat surface, rather than to an airplane-type plane). The “projected area” of a spinnaker sail refers to the size of the shadow that would be created by that sail, on a vertical plane or wall, when the sun is low on the horizon, and the sunbeams are horizontal at that location.

The amount of wind (and wind energy) that can be “caught” (or captured, harvested, etc.) by a sail does not depend on the amount of fabric in the sail; instead, it depends on the “projected area” of the sail, measured perpendicular to the wind. Since the winds in any locations suited for generating wind power will generally be horizontal, with only minor fluctuations, the projected area of a spinnaker sail will involve a vertical projection. That projected area will depend not on how much fabric is in the sail, but on the shapes and patterns of the reinforcing straps in the sail, since the straps will hold the sail in a certain configuration when it is being stretched to the maximum, by the wind.

By way of analogy, the horizontal cross-sectional area of a conventional round parachute, when open and in use, does not depend on how much fabric is in the parachute; instead, it is entirely controlled by the length of the outermost reinforcing strap. That strap will establish the circumference of a circular parachute, when the parachute is open; and, the circumference will determine and control the diameter, radius, and area of that circle. Factors such as how much fabric was used to make the parachute, or how high its dome might extend when in use, will have no effect on its projected area, and little if any effect on whether it will be able to safely hold and land a person or cargo package having a certain weight. The height of a parachute dome is designed for stability and safety; it cannot be so shallow and planar that a tilting motion might trigger a failure, in which the parachute would shift into free-fall mode, with a flattened planar shape plunging vertically through the air. However, the height of a parachute dome has essentially zero effect on how rapidly a person or item will descend, when hanging from that parachute. Instead, the rate of descent for a parachute holding a person or item having a fixed weight, and the amount of upward lifting force generated by a parachute at any particular speed will depend on its diameter, which is controlled by the outer reinforcing strap, rather than on the amount of fabric in the parachute (it should be noted, in passing that the upward force generated by a parachute will increase, as descent speed increases, until the upward lifting force is equal to the downward gravity force; the upward and downward forces will become equal, at some particular descent speed, and that speed becomes a steady and stable descent speed, often called the “terminal velocity”).

Similarly, the shape that a spinnaker sail will take, when deployed, will depend on the lengths, placements, and geometry of the reinforcing straps (which can also be referred to as constraining straps, holding straps, the “webbing”, or similar terms) which are incorporated into the sail. The reinforcing straps will be an integral part of the sail, and will be every bit as important to the size, shape, and performance of the sail, as the type, quantity, and projected areas of the fabric segments which are supported, held together, and held in position by the straps.

Issues involving “projected areas” and strap designs are discussed in more detail below, in the Detailed Description. In particular, a certain type of sail design, which uses a mechanism that can partially “reel in” certain straps during certain stages of a power cycle, can be used to shift an airborne spinnaker sail back and forth between: (i) a rounded dome-like shape, during each pulling stage of a power cycle; and, (ii) a relatively flat and planar shape, during each retrieval stage. That design may be novel, and patentable in its own right.

Since airborne spinnaker sails will be designed to handle different operating environments than spinnaker sails on sailboats, and since differences can arise between airborne versus nautical spinnaker sails, the phrase airborne spinnaker sail requires a definition. As described above, a “sail” is a segment or assembly of fabric or similar thin and flexible material which creates a horizontal force, when operated upon by wind, that will be imparted to a movable object, to help move the object. A “spinnaker” sail is a sail that is designed to be deployed in a manner which causes the largest “projected area” of the sail to be oriented perpendicular to the direction of the wind, so that the sail will “catch” the wind, and will be opened up to the fullest extent allowed by the construction of the sail, in a manner which will generate maximum pulling force in the same direction that the wind is blowing.

Accordingly, an airborne spinnaker sail (as that phrase defined and used herein, and in the claims) is a sail that is: (i) coupled to a buoyant aircraft or other lifting device, and used to convert wind energy into mechanical force; and, (ii) designed to be deployed in a manner which will cause the largest “projected area” of the sail to be oriented perpendicular to the direction of the wind, so that the sail will “catch” the wind, and will be opened up to the fullest extent allowed by the construction of the sail, in a manner which will generate maximum pulling force in the same direction that the wind is blowing.

However, that definition, as used herein, requires an additional qualifier. It is a straightforward task to design and assemble an airborne spinnaker sail in a manner which will act in an “ideal” manner, in terms of: (i) facing directly into the wind; and, (ii) generating maximal wind-driven pulling force. However, if the patent-claim definition of “airborne spinnaker sail” were limited to only ideal and optimized designs, which must function at perfect 100% efficiency levels (i.e., completely aligned with wind direction) in order to meet the definition set forth herein, then that type of patent-claim definition would create a simple, cheap, and easy way for competitors to sidestep and avoid such patent claims.

For example, by merely shortening the tethers on one side of a spinnaker sail, a “semi-spinnaker” sail could be manufactured and sold which arguably would be designed to operate at an offset angle with respect to the wind, causing it to have a slightly lower level of pulling power and efficiency (such as a 99% efficiency level, a 98% efficiency level, or any other controllably-reduced efficiency level); and, it would be a simple matter for the operator of an installation site to simply “straighten” the sail, to quietly return it to a 100% efficiency level without ever disclosing to anyone that it had done so.

To discourage and reduce that potential for abuse by competitors who want to sidestep a patent claim while using someone else's invention, and to avoid problems of interpreting and applying an idealized definition in an area of art where “hybridized” designs and adaptations abound, an arbitrary numerical standard is hereby set forth and incorporated into the definition of an “airborne spinnaker sail”. This “benchmark” standard can be referred to as “the 80% test”. If an airborne spinnaker-type sail (which might also be called a semi-spinnaker, sort-of-spinnaker, quasi-spinnaker, pseudo-spinnaker, etc.) is designed to align itself generally with the wind, but in a controllably imperfect and somewhat misaligned manner, or if it is otherwise deliberately designed and assembled in a non-optimal manner in order to create questions and grounds for arguments about whether it is or is not an actual “spinnaker” sail, then it will meet and satisfy “the 80% test”, and will fall within the definition of an “airborne spinnaker sail” as set forth herein, if both of the following two criteria apply: (i) if it is used to convert wind power into a mechanical pulling force that is used to generate electric power (either directly, such as by pulling a cable that is coupled directly to a generator shaft, or indirectly, such as by pulling a train loaded with generators to the top of a sloping or vertical track and then allowing the train to descend back down the track); and, (ii) if it generates an actual pulling force which is at least 80% of the pulling force that can be generated by a comparable airborne spinnaker sail made from the same quantity of material and using optimal design and operating parameters.

In addition, it also should be recognized that certain criteria which some sailing experts or glossaries might deem to apply to pure, true, classic, and archetypal spinnaker sails on sailboats may need to be altered and adjusted, when airborne spinnaker sails are adapted for use to convert wind power into electric power. For example, as mentioned above, most “classic” or “archetypal” spinnaker sails on sailboats utilize three “single-point” tethers to deploy, adjust, and furl the sail. Accordingly, some experts and glossaries might say that a spinnaker sail must have three single-point tethers, to qualify as a true spinnaker sail. Alternately, some experts and glossaries might state or imply that a “true” spinnaker sail must be entirely coupled to a sailboat only by means of single-point tethers.

However, narrow or rigid design parameters do not apply, when it comes to airborne spinnaker sails. As just one example of how an airborne spinnaker might differ from a “classic” spinnaker sail on a sailboat, the entire upper edge of an airborne spinnaker sail might be coupled to the trailing edge of a kite or airbarge, as illustrated in FIGS. 12 and 13, discussed below. So long as the definition set forth above is met (which requires the largest projected area of the sail to face into the wind, so that the sail will generate pulling force aligned with the wind), a sail which might not qualify as a “true” spinnaker sail, when strict nautical terminology is applied, may fall within the definition of an airborne spinnaker sail, if it is used while airborne to convert wind energy into mechanical pulling force.

Although the definition of “airborne spinnaker sail” does not address this issue, it is believed and asserted, by the Applicant herein, that it will be strongly preferable to provide some type of lifting mechanism or means, other than a spinnaker sail itself, that will keep a spinnaker sail aloft, since the sail itself should be designed and operated to generate maximal horizontal pulling force. That assertion is discussed in more detail below.

It also should be noted that the phrase, “single-point tether” does not require a tensile member to have only a single rope, cable, strap, or similar member along its entire length. Instead, in order to distribute and spread out a load or force in a manner which is less likely to impose bending, tearing, or other damaging forces and stresses on a structural component, it often is preferable to provide an expanded multi-component “interface” between a cable, and a sail or other structural component that will be constrained or operated upon by the cable. This type of “multi-component interface” can be visualized as being analogous to outstretched fingers, at the end of an arm. So long as a substantial portion of a tensile member qualifies as a “single-point tether”, then that entire tensile member falls within the definition of a “single-point tether” as used herein. Even if expanded or multi-component attachments (or any other devices) are used at both ends of a tether, if the entire tensile force which is imposed on a tether passes through a location where the entire tensile force must be borne by and conveyed through a single cable (or strap, chain, or similar flexible tensile member), then that tether qualifies as a single-point tether.

That completes a brief introduction to conventional spinnaker sails, and to conventional sailcloth. As mentioned above, a conventional spinnaker sails would be rapidly torn apart, if a boat owner tried to use it in 100 mile per hour winds, which rarely occur at ground level, and only in conjunction with major storms.

However, 100 or even 150 mph winds are not rare, or even especially unusual, at elevated altitudes.

Accordingly, one object of this invention is to create an electric power generating system which uses a combination of a gas-filled buoyant aircraft, and an airborne spinnaker sail, to convert wind power into strong pulling forces capable of generating large amounts of electric power, and which can be operated even in very high winds.

Another object of this invention is to create an assortment of airborne spinnaker sails to help convert wind energy into electric power, wherein the various spinnaker sails having different traits and operating characteristics, for selection and use depending on wind speeds that are occurring at some particular time, at some particular elevated altitude.

A fifth object of this invention is to disclose designs for airborne spinnaker sails which can withstand winds of greater than 100 or even 150 miles per hour, with no damage or degradation, while being used to generate large pulling forces that can be converted into electric power, without damage to the sails.

These and other objects of the invention will become more apparent from the following summary, drawings, and detailed description.

### SUMMARY OF THE INVENTION

New types of “airborne spinnaker sails” are disclosed, made from high-strength straps that are interwoven in a manner that preserves open space between them. These devices, referred to as “webbing sails” or simply “web sails”, are designed for use in conjunction with buoyant lifting devices, to capture and harvest wind energy in a way which will generate large mechanical pulling forces, which can be used to drive electric power generators. These types of web sails are designed to operate in winds that exceed 100 or even 150 miles per hour.

### BRIEF DESCRIPTION OF THE DRAWINGS

All drawings herein are identical to the drawings in simultaneously-filed U.S. patent application Ser. No. 13/217,873. Additional information on some of these drawings (including FIGS. 3-5, which are not essential to understanding this invention) is contained in that separate simultaneously-filed application.

FIG. 1 is a schematic depiction of a power generating system as described in published U.S. patent application Ser. No. 12/390,503, by the same applicant/inventor herein, which was published less than a year prior to the filing date of this applicatio. That system uses a combination of a buoyant aircraft and an airborne spinnaker sail to tow a heavy train, carrying multiple large and heavy electric generators, to the top of a sloping rail track installed on the side of a hill or mountain, during the ascent stage of a power-generating cycle.

FIG. 2 is a schematic depiction of the same power generating system shown in FIG. 1, during the descent stage of the power-generating cycle. As the train and generators roll down the sloping rail track, driven by gravity, rotation of the train wheels acts through a chain or gear system to drive the generators, thereby generating electric power. While the train is descending, the buoyant airbarge is rotated into a “nose down” angle, and the tension on the spinnaker sail is partially released, so that the sail will shift into a “flag” configuration; this will allow the airbarge and the sail to be “reeled in”, retracted, and returned to their starting positions with minimal power consumption, so that another power cycle can be commenced.

FIG. 3 depicts a first major inefficiency factor which severely limits the power output of conventional wind turbines. Only about 5 percent of the “swept area” of a wind turbine is occupied by the three fan blades. The wind blows freely—untouched, unused, unharvested, and unproductive—through the remaining 95% of that area.

FIG. 4 depicts a second major inefficiency factor which severely limits the power output of conventional wind turbines. There is a 90 degree (“right angle”) misalignment between the direction of the power source (i.e., the wind direction), and the direction of the power-harvesting device (i.e., the fan blade of a wind turbine).

FIG. 5 depicts third and fourth inefficiency factors which limit the power output of conventional wind turbines. In the center of the swept area, zero torque is generated, since that zone is occupied by: (i) the hub of the turbine motor; and, (ii) segments of the fan blade bases which have round (rather than slanted) cross-sections, for greater strength and structural support. In a second annular zone which surrounds the center “dead zone”, only a small quantity of torque is generated, since the distributed forces which press against the fan blades, in that near-center area, do not have an adequate “lever length” to help them generate substantial torque.

FIG. 6 depicts a “kite-manta-wing” (KMW) aircraft (referred to herein as an “airbarge”), filled with hydrogen and/or helium, with a tethering harness that puts the airbarge in a “nose up” angle, to generate additional “lift” and mechanical pulling force.

FIG. 7 is an elevation view, from the tail end, of an airbarge with a convex shape, indicating two outer and one inner vertical fins, all of which can extend the length of the airbarge, to help promote laminar flow of air across the upper and lower surfaces of the airbarge.

FIG. 8 is an elevation view, from the tail end, of an airbarge with a concave shape, with two outer and one inner vertical fins, to promote laminar flow of air across the airbarge.

FIG. 9, which includes panels 9A and 9B, is an elevation view, from the tail end, of an airbarge with a flexible frame, which will be pushed by wind force into a “scoop” shape with: (i) a concave lower surface, when the airbarge is flown in a “nose up” position during the pulling stage of a power cycle; and, (ii) a concave upper surface, when flown in a “nose down” position during the retrieval stage of a power cycle.

FIG. 10 provides a plan view (from above) of an airbarge, and depicts (although not to scale) the arrangement of: (i) a ground station mounted on a platform that can rotate to accommodate wind direction, with cable spools or windlass drums affixed to the shafts of electric generators; (ii) an airbarge with a transverse axle beneath it, coupled by tethering cables to the cable spools affixed to the generators at the ground station; and, (iii) a spinnaker sail, with its tethering cables attached to the tail end of the airbarge.

FIG. 11 depicts two airbarges in a vertical stack (or column, array, etc.), with a spinnaker sail tethered to the tail ends of the two airbarges.

FIG. 12 depicts a gas-filled buoyant airbarge, with a spinnaker sail attached directly to its tail end.

FIG. 13 depicts a wide and flat airbarge device which has been partially rolled up into a cylindrical “scoop” or “half-pipe” shape, with a spinnaker sail coupled to its tail end, and with a gap between the tail of the airbarge and the upper edge of the spinnaker sail.

FIG. 14 is a perspective view of an airbarge which has four propeller engines proximate to its “corners”. Each engine is mounted on an axle that can be used to rotate the engine into a lifting, descending, or thrust angle. These engines can provide greater maneuverability, especially for airbarges designed for multi-purpose use, such as for cargo, construction, or passenger transport. The engines also can be used as power-generating wind turbines, when not being used for other purposes.

FIG. 15, which includes panels 15A and 15B, depicts a spinnaker sail with a round projected area. When deployed, as shown in panel 15A, the sail has a dome shape, comparable to a parachute, established by a circumferential strap and various radial and concentric reinforcing straps. When collapsed into a flattened shape for a retrieval stage, as shown in panel 15B, the radial straps are retracted into a retractor device. A spreader device also is shown, between the airbarge and the sail.

FIG. 16, which includes panels 16A and 16B, is a cross-sectional cutaway view of a spreader device, positioned between an airbarge and a spinnaker sail. Panel 16A shows parallel reinforcing slats within the spreader, rotated into a direction that creates minimal wind resistance during low or moderate winds. Panel 16B shows the same reinforcing slats, rotated into slanted angles that will deflect and modulate wind flow during high winds, in a manner that will distribute and divide the wind force so that a portion of the forces and stresses are exerted on the spreader, in a manner that will help limit and control the forces and stresses imposed on the sail by high winds.

FIG. 17, which includes panels 17A and 17B, depict an elevation (side) view of an airbarge towing a spreader device (the spinnaker sail is not shown), in a “nose up” angle for a pulling stage in panel 17A, and in a “nose down” angle for a retrieval stage in panel 17B. FIG. 17 shows certain arrangements for coupling a spreader and sail to an airbarge, and for coupling ground cables to an airbarge.

FIG. 18 depicts a circular dome-shaped spinnaker sail with a network of radial and concentric reinforcing straps, and with a plurality of vents that can be opened, depending on wind speeds, to allow the sail to be deployed over a wider range of wind speeds.

FIG. 19 is a cross-sectional cutaway view of a spinnaker sail, with a “main body”, and an outer skirt (or apron, rim, or similar terms) affixed to its outer perimeter. In low or moderate winds, the skirt can be fully opened, as shown in panel 19A, to create a larger projected area with greater pulling power. In high winds, the skirt can be partially closed, to create a smaller projected area surrounded by sloped deflectors.

FIG. 20 depicts a “web sail” made of interwoven straps made of nylon, aramid, or other high-strength polymers. This web sail has an “open space percentage” of about 45 percent, for use during very high winds, including winds exceeding 100 or even 150 miles per hour.

FIG. 21 depicts a “web sail” made from interwoven straps with an “open space percentage” of about 25 percent, for use during strong but not extremely high winds.

FIG. 22, which includes panels 22A and 22B, is an elevation view from the tail end of an airbarge, which shows movable extender panels mounted on the outer vertical fins of the airbarge. The extender panels have been moved downward, in panel 22A, to a create a flow channel for wind on the bottom surface of the airbarge, to generate greater lift during a pulling stage. The same panels are moved upward for a retrieval stage, in panel 22B, to help the airbarge descend with minimal power consumption despite its buoyancy.

FIG. 23, which includes panels 23A and 23B, depicts a system in which retractable and extendable cables coupled to the tips and bases of the outer and center vertical fins can be used to alter the shape of an airbarge during each power cycle, to establish a “concave down” shape for the pulling stage, and a “concave up” shape during the retrieval stage.

FIG. 24 depicts a stationary airbarge, being used to support an axle or set of pulleys at an elevated altitude which allows an airborne spinnaker sail to travel in cyclic pulling and retrieval stages while coupled via cables to an electric power generating system.

### DETAILED DESCRIPTION

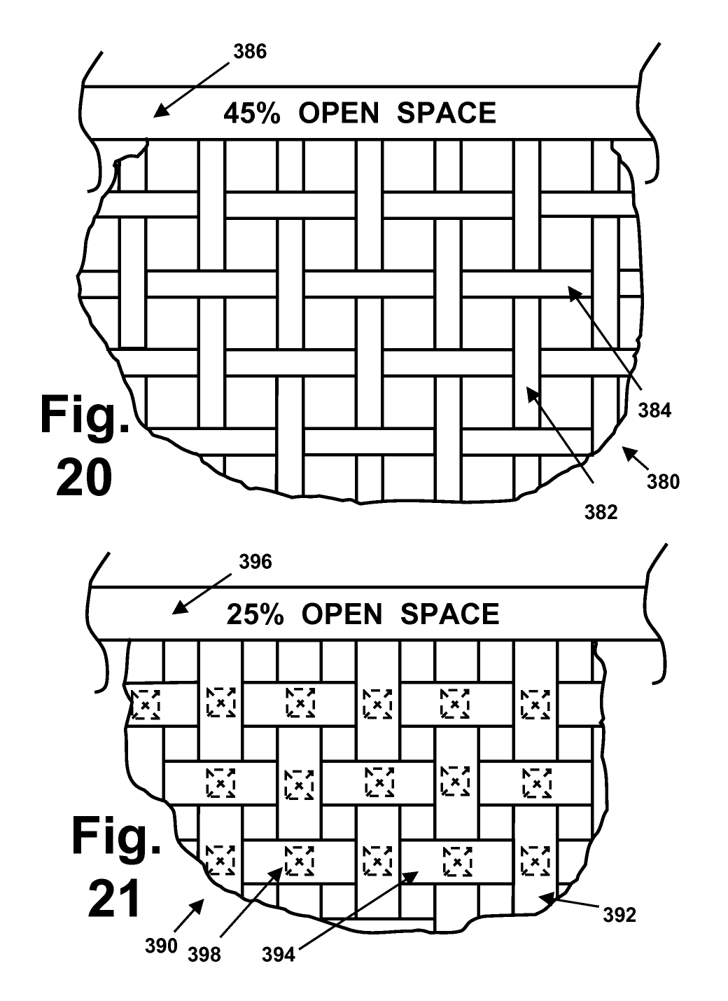

To ensure that the “disclosure of the best mode” requirement is fully satisfied, the entire discussion below is identical to the “Detailed Description” section in simultaneously-filed U.S. application Ser. No. 13/217,873. The section below which is directly pertinent to the “webbing sail” invention claimed herein is in a section below which is entitled, “WEBBING (OR WEB) SAILS”, and in FIGS. 20 and 21.

As briefly summarized above, this application discloses devices and methods that are designed to generate electric power, by capturing (or harvesting, converting, or similar terms) wind energy. One such device disclosed herein is an airborne traveling assembly referred to herein as an “airbarge and sail” unit (or system, assembly, etc.). It uses an airbarge (i.e., a wide and flat lifting device which will be unmanned during normal use), which is buoyant (i.e., filled with enough hydrogen or helium to overcome the weight of both the airbarge and the sail, in a manner which generates a net buoyant force that causes both the airbarge and sail to remain airborne unless mechanical means are used to force a descent), and which is sized and shaped to generate both lifting and pulling force, when allowed to rise into the path of the wind in a “nose up” orientation. Because of certain factors described in the Background section and below, it also is referred to as a “KMW” (kite-manta-wing) airbarge.

An “airborne spinnaker sail” (as defined in the Background section) is coupled to the airbarge, in a manner which allows the sail, when deployed and filled with wind, to exert a very strong pulling force, in a direction that is aligned with the wind.

Those two components are coupled, via one or more high-strength cables or other tensile members (made of stranded steel, aramid polymers, ultra-high-molecular-weight polyethylene, buckytubes, or other suitable materials) to a power conversion system which will convert the mechanical pulling force, provided by the airbarge-and-sail assembly, into electric power.

One type of electric power system that can be “driven” by the airbarge-and-sail system comprises a set of train cars carrying a set of large and heavy electric generators. The train and generators can be pulled (by wind-driven travel of the airbarge and sail, during the pulling stage of a power cycle), to the top of a vertical or sloping rail track (such as a track mounted on a hillside or mountainside, or on the side of a tall building, guyed tower, etc). The train can then be released from the towing cable. As the train descends (driven by gravity), rotation of the train wheels can be used to forcibly rotate the generator shafts, which can transfer electric power to the rails, or to cables mounted above or alongside the tracks.

Alternately, the airbarge-and-sail system can be coupled directly, via a cable system, to one or more rotatable components (which can be referred to as windlass drums, pulleys, or similar terms) which are coupled (either directly, or via gears, a chain-and-sprocket system, or similar means) to the shaft(s) of one or more electric generators. This can eliminate the need for additional expenses for a train and rail system.

As a third alternative, which likely will be preferred for at least some installations, a complete power-generating system as described herein can provide and utilize both: (i) “direct-pull” generators, and (ii) one or more sets of train cars with generators. The “direct-pull” generators can function during the day, from about 6 am until about 11 pm local time, when energy demand is high. During the night, when energy demand is lower, the airbarge-and-sail system can be used to tow train-and-generator units to the highest locations in one or more sloping or vertical tracks, so that the train(s) can descend and provide additional electric power during times of peak demand.

Regardless of whether a train system is included in a power-generating site, the airbarge-and-sail system will need to interact with a set of cable-handling equipment that is anchored to the ground. All pertinent equipment which remains anchored to the ground (including any housing unit(s) which shelter and protect the equipment) at any such site is referred to herein as a “ground station”. Depending on the specifics of any particular installation, it might also be called a base, a generator site or station, a gearhouse, a tower station or tower top, or other suitable terms which accurately describe that installation. In most cases, a “ground station” will contain a housing unit which shelters and protects a set of gears, pulleys, drums, sprockets, or similar cable-handling devices and equipment. If no train unit is involved, the ground station can directly house a set of electric generators. If a particular power system includes a train unit, the train and its tracks are not considered as part of the “ground station”; instead, the “ground station” will act as an “interface” between the airbarge-and-sail system, and the train unit.

In any location that does not involve a marine environment, any ground station preferably should be located on top of a hill, mountain, tall building, guyed tower, or other site or structure which is elevated above the surrounding terrain, to minimize possible entanglement of the airborne system with items on the ground. The housing (and any equipment it shelters) may be anchored (or affixed, mounted, etc.) on a horizontal platform which can rotate, to accommodate wind direction at any time; however, the platform, housing, and housed equipment will be “fixed” in the sense that they are anchored at that site, and will not travel away from that site. Accordingly, the “ground station” will remain in a fixed location, while the airbarge and sail travel away from the ground station during the “pulling stage” of each power cycle, and are then hauled or winched back to a starting point near the ground station, during the “retrieval stage” of each power cycle.

It also should be noted that a “ground station” can be located in a marine environment, such as offshore, or on a large lake. Since lakes and oceans have relatively flat surfaces, the risk of entanglements with buildings, ground protrusions, or other potential “catch” items can be minimized by operating over water. In such cases, the “ground station” can be a moored barge, a pier-type structure affixed to the seafloor or lake bed, or the offshore equivalent of a “guyed tower”.

### Pulling and Retrieval Stages of Power Cycles

In the above-cited parent application Ser. No. 12/390,503, which required a train-and-track system for a complete installation, the two major stages of a “power cycle” (or power-generating cycle) were referred to as the ascent and descent stages, since the train would clearly go through a repeating and reciprocating cycle of ascent and descent, on the sloping or vertical track.

However, since some systems disclosed herein do not require a train system, and use “direct-pull” generators instead, and since most of the actual travel of the airbarge and sail will be horizontal (driven by the wind) rather than vertical ascents and descents, the terms “ascent” and “descent” are no longer used, since they might be misleading to some readers. Instead, the two major stages (or portions, components, etc.) of a power cycle are referred to herein as:

(1) a pulling stage, which will occur as the airbarge and sail are being driven and pulled, by the wind, in a manner which takes them farther away from a ground station; and,

(2) a retrieval stage, which will occur when the airbarge and sail are shifted into “low resistance” modes and are “reeled in” by a winch or similar system, to return them to a starting point which will be reasonably close to the ground station, so that they will be ready to begin another power cycle.

The “pulling stage” is the stage or component that occurs while the force of the wind is being “harvested” (or captured, converted, or similar terms) in a manner that will convert it into useful mechanical work, which can be converted into electric power. That useful mechanical work may take the form of either: (i) towing a train to the top of a sloped or vertical track; or, (ii) forcibly driving the rotation of electric power generator shafts.

Alternately, it also should be noted that useful mechanical power and work might also be captured in various other ways, especially if smaller, scaled-down systems are involved. Instead of limiting the use of these types of wind-to-electricity systems to large “wind farms” which cost tens of millions of dollars and which therefore are suited only for electric utility companies or large corporations to install and operate, many factories, office buildings, apartment complexes, or even single-family homes could afford to install an airbarge-and-sail system. As a “ballpark estimate”, a modestly-sized airbarge likely could be manufactured at a cost comparable to a fishing boat or sailboat, and all other necessary components (the sail, generator, retrieval winch, etc.) likely could be purchased and installed for less than the cost of a new car. Accordingly, as weather upheavals in the US and elsewhere, combined with other events (such as the 2011 tsunami and nuclear disaster in northern Japan) force the governments and citizens of the world to begin facing up to the realities of climate change, the system described herein can be “scaled down”, for purchase and use at sites such as factories, office buildings, apartment complexes, or even single-family homes, far more easily than competing systems such as wind turbines.

Furthermore, when smaller units are involved, it becomes more feasible and practical to couple them to various other types of power-converting or power-utilizing devices. The creation and development of such devices is limited only by the ability of tinkerers, mechanics, engineers, and inventors to find ways to convert mechanical power into useful work. As a few examples, a heating device, for use during winter or to heat a swimming pool, could be constructed around a machine that uses friction to generate the heat. Similarly, in air conditioning systems, compressors and fans require large amounts of power; they normally use electric power, but they can be coupled to mechanical drives, or to hybridized electro-mechanical drives in which electric power is used only if insufficient mechanical power is available. Similarly, mechanical power systems can be coupled to various types of fuel cells, and shared driveshafts can be used to help drive machines in a factory. Rotating overhead driveshafts, with various types of belt, chain, and gearing systems that allowed numerous machines to be coupled to a single overhead driveshaft, were common in factories, before the advent of cheap electric power motivated companies to get rid of them. Those systems became very well known, and could be revived and used again, to reduce electric power consumption in factories or other installations that use airbarge-and-sail systems to drive a shared driveshaft.

Furthermore, a modestly-sized airbarge-and-sail system can be used to drive a system which would act in a manner analogous to a “surge tank”, which would convert a series of time-dependent surges (or pulses, or similar terms) of pulling power, into a steady and stable supply of available power. For example, a reciprocating weight-lifting system can be designed which would use intermittent surges of wind power, provided by an airbarge-and-sail system, to lift multiple tons of weight (which can be provided inexpensively, by materials such as rocks and sand) to a fixed height. That type of system can be designed with a gearing or belt system that will divide a fixed quantity of pulling power (generated by an airbarge-and-sail system) into two distinct “streams” or fractions. During each pulling stage, when pulling power is being provided by the airbarge and sail, half of that power can be made available directly to users, while the other half can be used to lift tons of weight to a taller height, within a mechanical support system that is comparable to the types of “weight machines” that are found in fitness and workout centers, which have stacks of weights that repeatedly travel up and down a set of fixed vertical shafts or rails (or which hang down from the ends of chains that pass across a row of sprockets or gears that are coupled to a driveshaft). During each pulling stage, half of the pulling power can be used to lift tons of weight to a taller height. Then, during the retrieval stage of each power cycle, when the airbarge and sail are being reeled in closer to the ground station, the weights will descend, in a manner which provides a power supply to the users.

Accordingly, these types of devices and machines can be used to convert mechanical power into useful work output, over a wide range of sizes and scales, ranging from large “wind farms” operated by electric utilities, down to systems which can provide power for factories, office buildings, apartment complexes, or even single-family homes.

Therefore, the invention herein resides in “airbarge and airborne spinnaker sail” combinations, which can convert wind energy into mechanical force, power, and work, regardless of which particular type of mechanism or system may be used to convert that pulling power into electric power, or into any other form of useful power output or work.

“Kite-Manta-Wing” (KMW) Airbarges

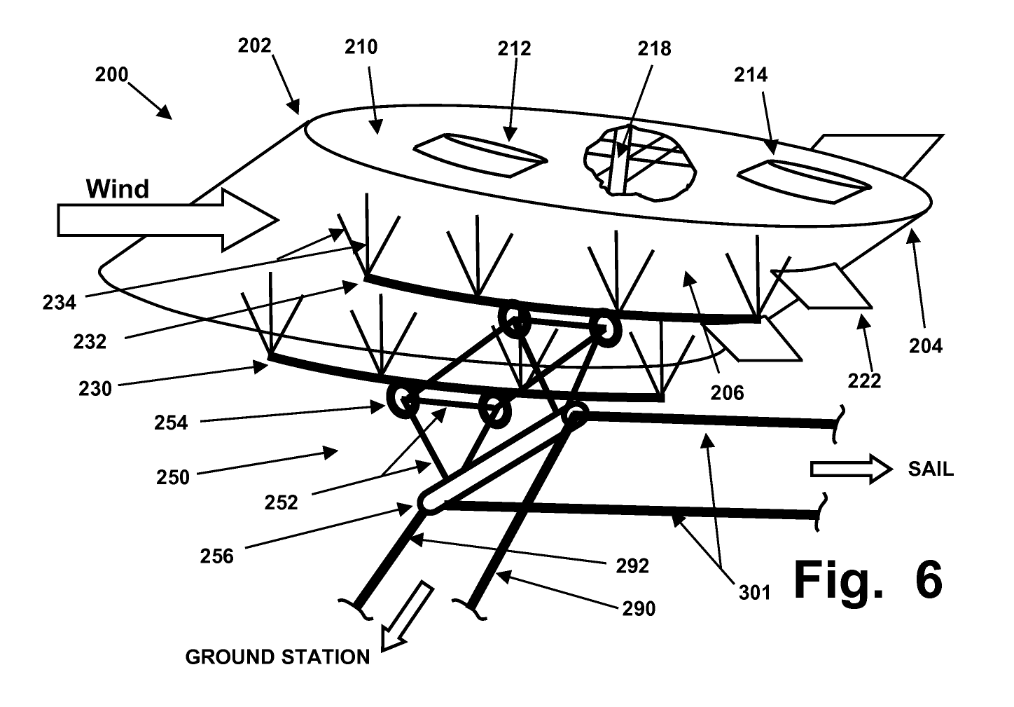

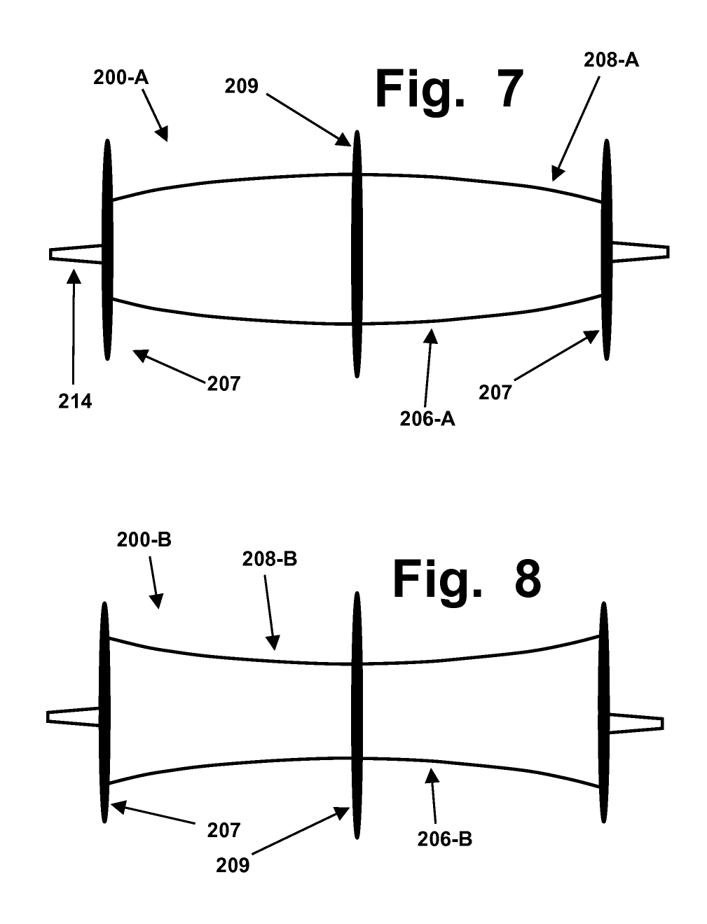

As mentioned in the Background section, a hydrogen- and/or helium-filled buoyant aircraft 200, as illustrated in FIGS. 6 and 7, is referred to herein as a “kite-manta-wing” (KMW) aircraft, since it can combine various traits of: (i) a kite, i.e., a thin planar device which generates lift by presenting an angled undersurface to the wind; (ii) a manta ray, which shifts and alters its external shape to travel in a controlled manner; and, (iii) a wing (or a “flying wing” aircraft) which has a cross-sectional shape (when seen from the left or right side) called an “airfoil” which generates lift (i.e., upward vertical force) when air passes over and under it at a substantial velocity.

In addition to the “KMW” label, the buoyant airship also is referred to herein as an “airbarge”, since it will have a wide shape (comparable to a barge which floats on water), and since it normally will be unmanned. The wide shape can both: (i) help the aircraft generate lift and pulling power, when flown “nose up” into the wind during each pulling stage; and, (ii) help it descend, despite its buoyancy, when flown “nose down” during each retrieval stage.

All comments and teachings contained in parent application Ser. No. 12/390,503, relating to the buoyant airbarge referred to as “zeppelin 150” therein, are incorporated herein by reference, as though fully set forth herein, and apply to the KMW airbarge 200 as described and illustrated herein. As just one example, as stated in the parent application, since these airbarges will be designed to operate unmanned, any or all of the internal compartments which hold the buoyant gas can be filled with either: (i) helium, which is safer than hydrogen; (ii) hydrogen, which is cheaper and more buoyant than helium; and/or, (iii) a mixture of hydrogen and helium.

FIG. 6 is a perspective view of KMW airbarge 200, showing nose end 202 (which can also be called the bow, front, or similar terms), tail end 204 (which can also be called the stern, rear, aft, or similar terms), and bottom (or lower, under, etc.) surface 206 (top surface 208 is depicted in FIGS. 7-10). All of those outer surfaces are provided by a gas-impermeable envelope made of a material which will contain and enclose a buoyant gas (i.e., hydrogen and/or helium gas); such materials can be provided by various known means, such as: (1) coating a thin polymeric film onto a sheet of woven or knitted fabric which can provide relatively high levels of strength and tear resistance to the material; or, (2) using known manufacturing techniques to create a polymeric sheet which can provide its own desired level of strength and tear resistance. The gas-impermeable envelope is illustrated, in the drawings, by the upper, lower, and side surfaces 206-210.

A cutaway panel in FIG. 6 is used to depict a combination of vertical, transverse, and longitudinal struts or straps, which collectively will provide a “load-bearing support structure” for airbarge 200. In relatively large airbarges, at least some of the internal load-bearing components likely will be made of stiff or rigid materials (such as aluminum, graphite, etc.), to form the type of internal structure that is commonly called a frame (alternate terms can be used, such as scaffold, skeleton, etc.). Such stiff or rigid frame components can be bolted, riveted, welded, or otherwise securely coupled together, and such coupling means can also include hinges, sliding and/or telescoping components, or other movable devices, to enable an airbarge to be compacted into a smaller size when appropriate, such as for storage, for protection during storms, or for deployment with a smaller projected area during high wind conditions.

In smaller airbarges, if a “net positive gas pressure” is sustained inside the envelope (i.e., to keep it inflated), at least some and potentially all of the “load-bearing support structure” components can be made from high-strength straps, which can be coupled to each other by stitching, rivets, weaving or interlacing, or other means.

In FIG. 6, several vertical tail fins 222 are depicted in a relatively small form, to avoid cluttering FIG. 6. As described below and as illustrated in FIGS. 7-10, in a preferred embodiment, the vertical fins can extend the entire length of the airbarge, and are classified as: (i) outer (or side) fins 224, which will extend along or near the left and right (port and starboard) sides of an airbarge; and, (ii) one or more inner (or medial, center, etc.) fins 226.

The left (port) side surface 210 of airbarge 200 is shown in FIG. 6, with forward fins or wings 212, and rear (aft) fins or wings 214. These fins or wings, which can have any desired length and width (which will vary, among different airbarges) preferably should be mounted on rotatable axles or plates, to allow the angle or “trim” of the wings or fins 212 and 214 to be adjusted during ascent and descent. If desired, any such wings or fins can also be provided with flaps, ailerons, spoilers, or other movable components, as used with conventional fixed-wing aircraft.

The perspective in FIG. 6 illustrates two hanging rails 230 and 232, mounted longitudinally (i.e, nose-to-tail), and positioned proximate to the left (port) and right (starboard) sides of the airbarge 200. Each rail is coupled to a strong internal frame (not shown) of airbarge 200 by a number of vertical and/or slanted attachment struts or straps 234, which are distributed across a relatively wide area of the internal frame. For simplicity of illustration, only two longitudinal rails are shown in FIG. 6; if desired, a larger number can be provided.

A traveling frame 250, made of rigid strut and crossbar components 252, and attached to four wheels or gears 254, is suspended beneath rails 230 and 232. The wheels or gears 254 are provided with a source of electrical or other power, and are coupled to the rails 230 and 232 in a manner which effectively locks the wheels to the rails while allowing the wheels and the entire traveling frame 250 to “crawl” along the rails, in a secure and controllable manner, at appropriate times. This type of conveyance system can use any of various types of mechanisms that have been developed for “hanging rail” systems, which are used in various types of factories, amusement parks, ski lifts, etc. To ensure proper positioning at all times, the mechanism which allows the wheels or gears to grip the rails should not allow any sliding motions; instead, it should use a suitable mechanism (such as a gear system, a chain-and-sprocket system, a threaded-shaft system, etc.) to provide a level of strength and control that will be appropriate for any particular airbarge having a known size, shape, and buoyant force.

The tethering frame 250 also supports and provides a tethering axle 256, which will maintain a “transverse” (left-to-right) orientation as the traveling frame moves along rails 230 and 232, beneath airbarge 200. Tethering cables 290 and 292 are coupled at or near the ends of the tethering axle 256. This will maintain a substantial distance between the left and right tethering points, and it will establish a transverse linear row of tethering points, which will move in an aligned manner toward either nose end 202 or tail end 204 of airbarge 200, when appropriate during a power cycle.

It should also be mentioned that a “double-harness” or “four point” connector system, such as a system which uses two different transverse axles, with one axle closer to the nose of the airbarge while the other is closer to the tail of the airbarge, may be able to provide greater stability against “pitching” or “bucking” motions of an airbarge, in gusting winds. Alternately or additionally, if the ground cables are coupled to a harness system which is suspended beneath an airbarge, and which effectively divides the attachment points for the harness between the front and the back of the airbarge, in a manner which creates a longer and taller vertical “radius” for any unwanted pitching or bucking motions, that type of harnessing system also would help suppress unwanted “pitching” or “bucking” motions by an airbarge. As a general principle, if the transverse axle or other device (or set of devices) where the ground cables are attached is too close to the transverse “centroid” (i.e., the location of the so-called “center of gravity” or buoyancy) of an airbarge, it will be harder to suppress unwanted pitching motions. By contrast, if the ground cables are attached to the airbarge along a line which is a substantial distance below the centroid of the airbarge, the airbarge would need to travel through a larger and longer arc, during each nose-down or nose-up pitching motion. Therefore, positioning an attachment axle or other device a sufficient distance below an airbarge can help suppress unwanted pitching motions.

The ability of a tethering system which can travel in both fore (i.e., toward nose end 202) and aft (i.e., toward tail end 204) directions, to alter and control the “pitch” of the airbarge at all times during a power cycle, merits a brief explanation.

First, the terms “pitch” and “pitch control” require attention, because they are used in inconsistent and potentially confusing ways, when referring to boats and airplanes. When applied to boats, “pitch” and “pitching” refers to an unwanted type of motion in which a boat rocks forward and backward, around an imaginary horizontal left-to-right (transverse) axle. That type of rocking motion causes both the bow (front) and stern (back) to move in alternating upward and downward directions. By contrast, the word “trim” refers to a relatively stable bow-to-stern angle of a boat, as it moves through the water or rests in the water. Every boat will have some type of proper and stable “trim” as it sits in or moves through the water at any given speed. Accordingly, experienced sailboaters learn how to “trim” the sails, in ways that will establish an optimal “trim” for the entire boat under varying wind and wave conditions.

When applied to aircraft, the word “pitch” still covers and includes unwanted front-to-back rocking motions, as mentioned above. However, the nose-to-tail angle of an airplane is not affected by uncontrollable wave motions, and it can be much more tightly controlled, during takeoff, flight, and landing, by using the flaps, elevators, spoilers, and other movable components of the wings and tail of an airplane. Therefore, the term “pitch”, when applied to airplanes, gradually came to refer to the nose-to-tail angle at which an airplane flies through the air. In other words, the term “pitch”, when referring to an airplane, generally has the same meaning as the word “trim”, when referring to boats.

Accordingly, in boats, the term “pitch control” refers to devices and methods used to prevent or minimize unwanted bow-to-stern rocking motions. By contrast, when referring to aircraft (and when used herein), “pitch control” refers to methods and devices for establishing and sustaining a desired and stable nose-to-tail angle (i.e., “trim”) of an aircraft, during any stage of a flight operation (or power cycle, when used herein).

Returning to how a traveling frame 250, as shown in FIG. 6, can provide pitch control for a buoyant airbarge, if a “transverse” (left-to-right) line of tethering points, as maintained by tethering axle 256, moves closer to tail end 204 while traveling along rails 230 and 232, the tail end 204 will be pulled closer to the downward-pulling tethering cables 256, while the nose end 204 (filled with a buoyant gas that will always seek to rise up as high as possible) will simultaneously move farther away from the downward-pulling cables. Those two effects will cause the KMW airship to rotate into more of a “nose up” orientation (i.e., in a clockwise direction, in FIG. 6), as frame 250 travels toward tail end 204.

Conversely, if tethering axle 256 travels in a forward direction toward nose end 202, it will pull the nose 202 closer to the downward-pulling cables, while the tail end 204 will move farther away from the cables and rise higher into the air. That will cause the KMW airship to rotate into more of a “nose down” orientation.

Accordingly, a lateral (side-to-side) tethering axle which can be moved either forward or backward, in a controlled manner, will provide a control mechanism that can be used to adjust and control the nose-to-tail angle (i.e., the “pitch” or “trim”) of the airship at all times, during each power cycle.

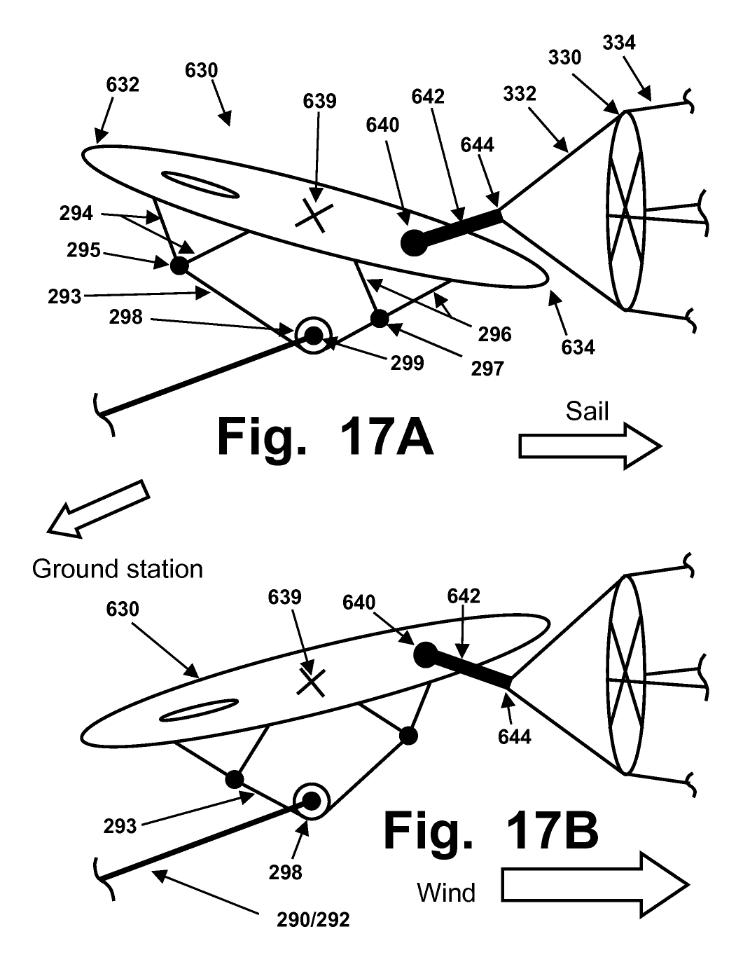

An alternate mechanism for accomplishing the same result, using a gear or geared axle which travels along one or more segments of chain (and which eliminates the requirements for a set of stiff or rigid rails suspended beneath an airbarge) is depicted in FIG. 17.

The optimal pitch, for any particular airbarge having a certain size and shape, for either a “nose up” angle during a pulling stage or a “nose down” angle during a retrieval stage, will vary, depending on wind conditions. As a general rule, a relatively constant level of tensile force and pulling power is desirable. Therefore, when wind speeds are high, the “pitch” of the airbarge at any moment (during either a pulling stage, or a retrieval stage) should be reduced, and the airbarge should be flown at a “shallow” angle, which is closer to horizontal. By contrast, when wind speeds are lower, the pitch should be increased, and the airbarge should be flown at a “steeper” angle or slope.

Tethering axle 256 also can provide a candidate location for attaching the sail-tethering cables 301 and 302, as indicated in FIG. 6. If that type of attachment is used, spinnaker sail 300 will not exert any rotational force on the airbarge 300, which otherwise might alter and affect the pitch of the airbarge during a pulling cycle. In an alternate design, depicted in FIG. 17 (described below), the rearward pull of a spinnaker sail can be used to help prevent and minimize any unwanted pitching or bucking motion of an airbarge, in a manner which also can be used to help control the flight angle (“trim”) of the airbarge.

Concerning the cables that couple an airbarge to a ground station, traveling frame 256 can be provided with resilient and/or shock-adsorbing mechanisms, such as the types of components designed for chassis and suspension systems for trucks and tractors, which include leaf and coil springs, rubber discs or sleeves placed between metal plates, shock absorbers, etc. Alternately or additionally, depending on the size and operating parameters of an airbarge, the longitudinal rails suspended beneath it can be replaced by a set of strongly reinforced flexible straps.

If desired, and especially for smaller airbarges, rails made of metal alloys or other stiff materials might be replaced by reinforced straps or belts, made of nylon or other higher-strength polymeric fibers with tensile strengths of a dozen or more tons per strap. Alternately, FIG. 17 depicts a coupling system which uses two or more segments of chain, coupled to fore and aft attachment points.

If flexible straps, belts, or chains (rather than stiff or rigid rails) are used, concerns will arise which will center on the number, spacing, and location of any additional vertical or slanted reinforcing struts or straps that should be used to strength the “main” longitudinal straps, especially in a relatively large airbarge. Accordingly, if a “suspended rail” mechanism is used to provide pitch control for an airbarge, rails are likely to provide a preferred mechanism for initial development and use, since they will allow testing, under a range of wind and weather conditions, to determine how much forward and aftward travel, by a traveling frame or axle, will be required to provide enough pitch control for all conditions that are likely to be encountered at various installations. If the required travel distance is relatively short, then flexible straps, belts, or chains can provide additional options which may be preferable for some designs.

Regardless of whether rails, straps, or chains are used, all attachments of any suspended or other structural components, to an airbarge, must be coupled to a strong internal frame (or skeleton, scaffold, webbing, etc.), so that high stresses will not be imposed on the skin of the airbarge, which will be made of a thin and flexible polymer.

Alternately or additionally, various other candidate means can also be provided and used to help control the pitch (or trim) of an airbarge, at any moment in time during a power cycle. Such means include, for example:

(1) Using a fan or compressor to transfer hydrogen or helium gas back and forth between alternate chambers, proximate to the nose and tail ends of the airbarge;

(2) Providing one or more “piggy-back” chambers, filled with hydrogen or helium, which can travel along the length of the airbarge, presumably on its top surface.

(3) Mounting any pumps, compressors, tanks, or other weighted equipment on a structure (which can be referred to as a frame, wagon, tray, or similar terms) that can travel toward either the nose or tail of the airbarge.

(4) Using a different type of tethering system with an alternate design, having one set of straps or cables attached proximate to the nose of the aircraft, and another set of straps or cables attached proximate to the tail of the aircraft, with each set of straps or cables coupled to one or more cables which either extend all the way to the ground, or which are coupled to a control mechanism that is suspended at a suitable height below the airbarge.

(5) Providing one or more sets of wings or fins along the lateral (right and left; port and starboard) sides of the airbarge. The term “wing” implies a relatively large structure which will actively contribute “lift” to an aircraft, while the term “fin” implies a smaller structure which is used mainly for steering and control, rather than for generating lift. There is no clear dividing line between those terms, and a fin-type structure with a size midway between a “wing” and a “fin” can be referred to by either term. FIG. 6 depicts both a forward lateral fin 212, and an aft lateral fin 214. Each fin is mounted on a rotatable axle, plate, or similar mounting component; this allows their angle or “pitch” to be controlled, at any time, by rotating the axle, plate, or other mounting component.

In most cases, various different pitch-control mechanisms can be used simultaneously, to provide greater levels of control over the pitch of an airbarge at any moment in time.

FIGS. 7, 8, and 9 illustrate three different candidate shapes for buoyant airbarges, when viewed from behind the tail end. Each candidate shape has a combination of advantages and limitations; accordingly, a routine testing program which is within the ordinary skill in the art (using computer modeling, as well as scale-model testing in wind tunnels) will indicate which particular shape will be optimal for various combinations of: (i) different barge sizes; and, (i) a range of wind velocities which will occur at any candidate installation site.

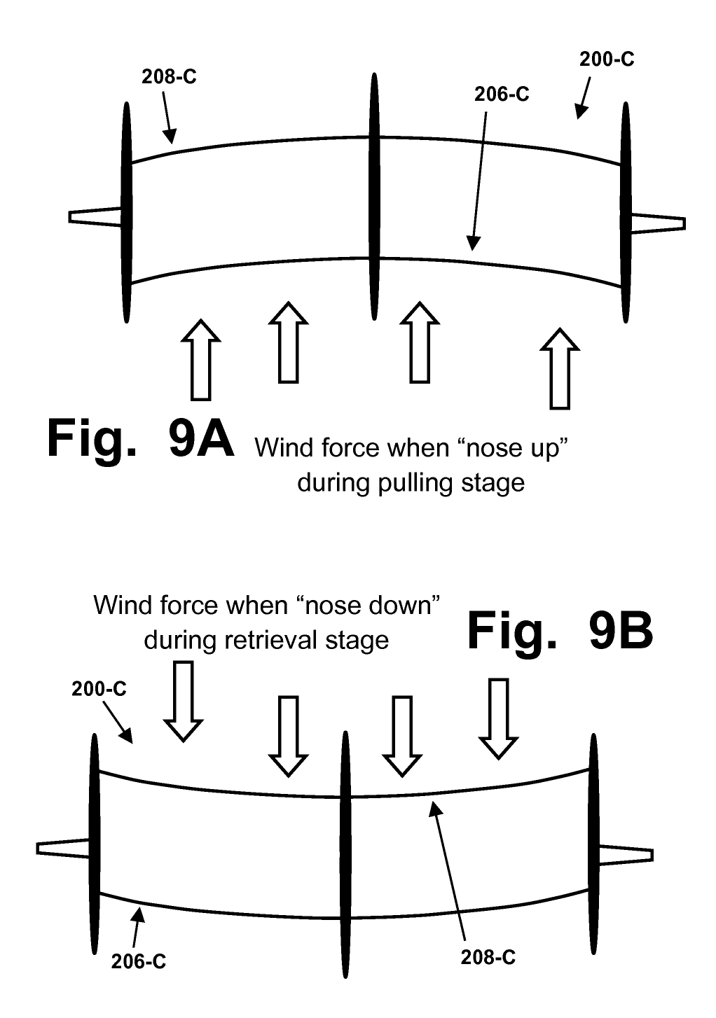

Briefly, the airbarge shapes in FIGS. 7-9 can be referred to, respectively, as: (i) a convex shape for airbarge 200-A, as shown in FIG. 7; (ii) a concave shape for airbarge 200-B, as shown in FIG. 8; and, (iii) a “scoop” shape for airbarge 200-C, as shown in FIGS. 9A and 9B.

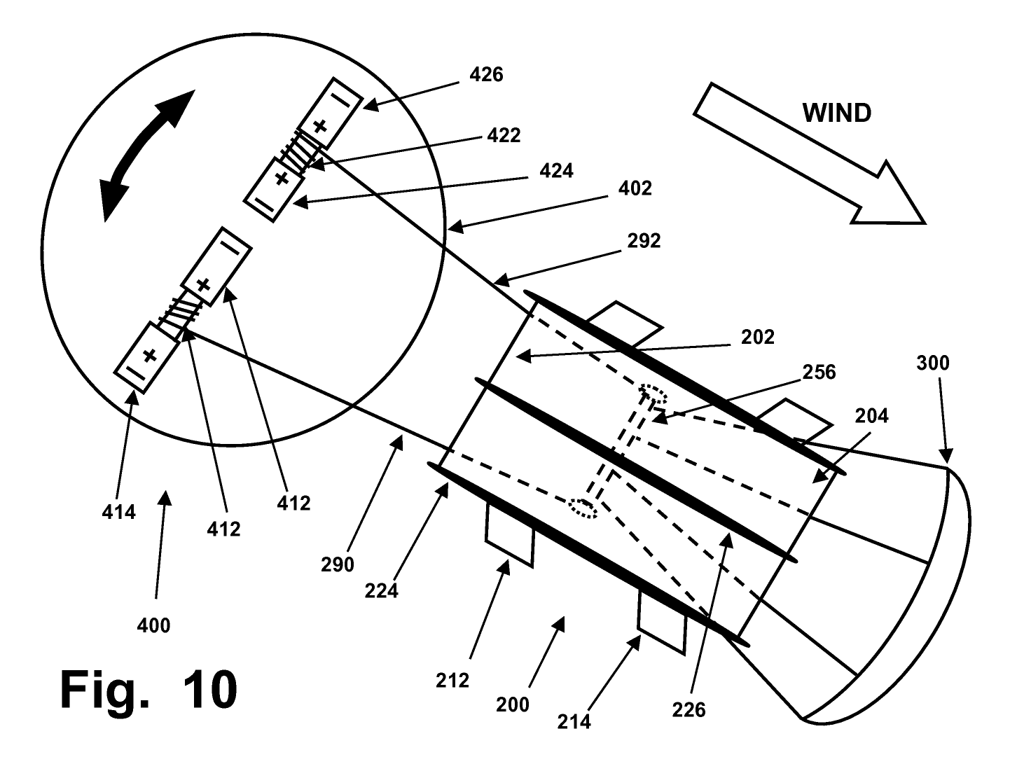

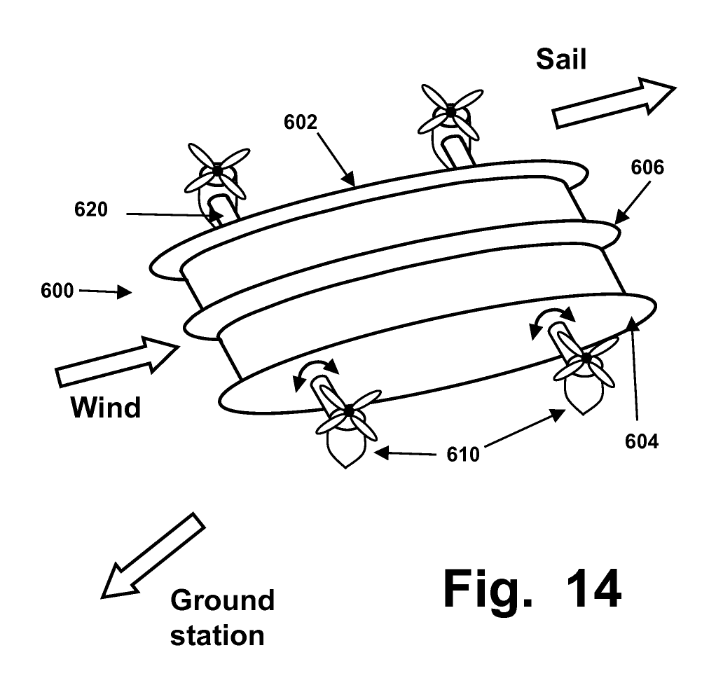

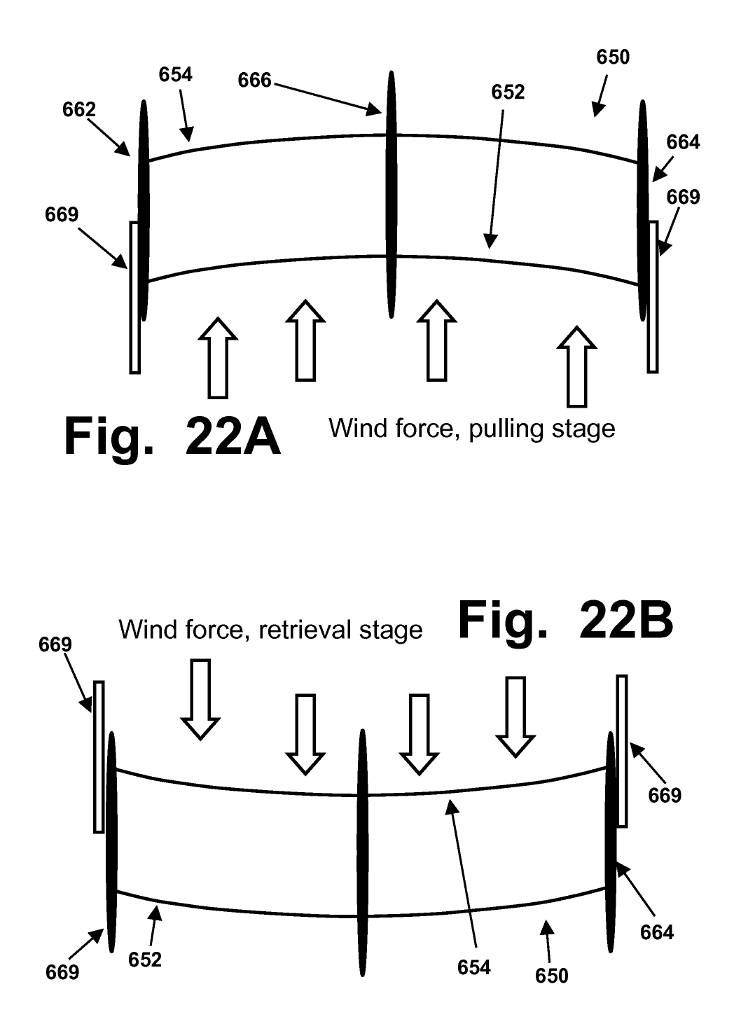

For all three barge shapes, two outer fins 207 (which can also be called side fins, port or starboard fins, or similar terms) are shown, and a single inner (or center, medial, etc.) fin 209 also is shown. To help minimize wind turbulence and promote “laminar” wind flow across the entire length of an airbarge, any or all of the vertical fins 207 and 209 can extend to cover the entire length of an airbarge, as depicted in FIGS. 10 and 14. Alternately, vertical fins can be provided that have any other continuous or intermittent length and/or spacing, if computer modeling, scale-model testing, and emulations of various fin arrangements that have evolved in fish or eels indicate that any such arrangement will optimize the overall performance of an airbarge as described herein. Furthermore, if it is shown that adjustments and alterations to the heights, lengths, or other dimensions or placement of any vertical fin(s) will help optimize performance of an airbarge in different wind or weather conditions, or the performance of airbarges within certain size ranges, such changes and adjustments can be made, by coupling movable vertical fin components to gearing, hydraulic, pneumatic, or other control systems which can slide a movable plate-type structure along a pre-set track (an example of such a system is shown in FIG. 22).

It also must be emphasized that factors such as: (i) the exact cross-sectional shape of an airbarge (such as the convex, concave, and scooped shapes shown in FIGS. 7-9); and, (ii) the lengths, heights, number, placements, and other parameters that apply to both vertical and horizontal fins or flaps, are within a realm that involves optimization, rather than basic functioning. Such changes may be able improve efficiency by a few percentage points, when measured in terms of “net pulling force”, “net electric power output”, or “megawatts of power output per dollar of installation and operating costs”; however, that type of “tinkering” and “tweaking” is not required, in order to establish functionality and good performance, when an airbarge-and-sail system is designed and used as disclosed herein. Any of the airbarge cross-sectional shapes shown in FIGS. 7-9, and any conventional and suitable set of vertical fin components as shown in any of FIGS. 6-9 and 22, will place an airbarge within a realm of performance and efficiency which will render such a system useful and effective over a wide range of airbarge sizes and wind conditions.

Returning to the selection of convex, concave, and scooped shapes shown in FIGS. 7-9, their advantages and disadvantages can be briefly summarized and compared as follows:

(i) A convex shape, as shown for airbarge 200-A in FIG. 7, with lower surface 206-A and upper surface 208-A both being pressed and held in an outward direction by internal gas pressure, is a more natural and normal shape than either of the designs shown in FIGS. 8 and 9, for an inflated bladder with a thin and flexible outer skin. Accordingly, this shape can be achieved with less expense and lower weight requirements than either of the other two shapes, especially with regard to how the outermost skin will be coupled to any internal frame and/or strap components. In addition, since it will hold more hydrogen or helium than a comparably-sized airbarge with one or two concave shapes, it can generate greater buoyant lifting power than either of the other two shapes. However, it does not provide the type of “scoop” shape, on bottom surface 206-A or top surface 208-A, which can help channel wind flow along the length of the airbarge in an “actively contributing” manner that can help improve the efficiency of the system. In addition, since a rounded and convex shape has a larger cross-sectional area and size than a concave shapes with the same overall height and width, and will therefore need to displace more wind over a greater distance compared to a concave shape, a convex airbarge will create higher levels of “drag” (i.e., horizontal resisting force), which will require more power to overcome, each time the airbarge must be “reeled in” during the retrieval stage of each power cycle.

(ii) A concave shape as indicated for airbarge 200-B in FIG. 8, which is concave both on bottom surface 206-B and top surface 208-B, will not create as much buoyancy as a convex shape. In addition, it will pose additional challenges in attaching the outer skin to an internal frame or other support structure, in ways which must not breach, jeopardize, or severely stress a thin and flexible gas-tight membrane. On the positive side, a concave shape can effectively act like a trough or “scoop” which will help channel the wind and allow the airbarge to use the wind in an optimal manner. If the bottom surface is concave, it can help maximize vertical lifting and pulling forces that the airbarge will generate, during each pulling stage; and, if the top surface also is concave, it can help generate greater downward forces, which will help counteract the buoyancy of the gas, and minimize the amount of power that is required to “reel in” an airbarge, during each retrieval stage. In addition, as mentioned above, a concave airbarge will not create as much resistive “drag” which must be overcome, as it is being pulled back to a starting position during each retrieval stage.

(iii) A cross-sectional shape referred to herein as a “scoop”, with one side convex while the other is concave, as indicated in FIG. 9, which includes panels 9A and 9B. This shape can offer a potentially useful compromise between a fully convex shape, as in FIG. 7, and a fully concave shape, as in FIG. 8. This compromise becomes even more appealing and useful, if an airbarge can utilize wind pressure to help it shift back and forth between a “downward” scoop shape during a pulling stage (when the airbarge is being flown in a “nose up” angle) as depicted in panel 9A, and an “upward” scoop, during a retrieval stage (when the airbarge is being flown in a “nose down” angle) as depicted in FIG. 9B.

Both of those two panels use arrows to indicate how a “distributed force” from wind pressure will press against bottom surface 206-C during a pulling stage, and against top surface 208-C during a retrieval stage. Accordingly, rather than using extra machinery (which translates into additional weight, additional costs, etc.) to create a “scoop” shape which alternates back and forth between upward and downward directions, a preferred embodiment involves providing an airbarge frame with sufficient flexibility to enable it to use the force of the wind, which will press in an alternating manner against the top and bottom surfaces during the different stages of each power cycle, to generate concave “scoop”-type shapes that will alternate between the top and bottom surfaces, when desired.

Alternately or additionally, if desired, mechanical means can be provided which will act in a manner that supplements distributed wind pressure, to fully optimize the shape of an airbarge for each pulling stage, and then create a different optimal shape for each retrieval stage. Those options, and the types of mechanisms that can be used to change the shape of a large buoyant airbarge while it remains in flight, are discussed in a separate section, below.

As mentioned above, if an effort is made to create a concave outer shape from a thin and flexible membrane, it will require careful attention, because the outer skin must be completely “gas tight” to hydrogen and/or helium, which are very small molecules (hydrogen gas has a molecular weight of only 2, compared to 32 for oxygen and 28 for nitrogen, which make up most of the air). Nevertheless, suitable methods for creating gas-impermeable polymeric films are well within the skill of the art, among those who are experienced in manufacturing buoyant aircraft, large buoyant balloons used in parades, and other items that use large sheets of polymeric materials. Two examples of the types of methods that can be used to assemble gas-impermeable concave surfaces can be briefly summarized as follows:

(1) Large sheets of gas-impermeable polymers can be molded into any desired size and shape, by spraying or otherwise coating a thin layer of a pre-polymeric liquid onto a molding surface; alternately, a sheet of polymeric material can be bonded to a molding surface, by using heat and/or a suitable solvent along with pressure. After that forming step is completed, the shaped polymeric sheet is gently pulled away from the molding surface, which can be coated with a release agent prior to the spraying or shaping operation, if desired. The shaped sheet can then be bonded to frame or strap components which will establish and control the final shape of the object, by using contact adhesives, a heat-sealing and/or solvent treatment, or similar means which will not alter or damage the gas-impermeability of the polymer sheet.

(2) Alternately, a gas-permeable fabric, made of materials such as woven or knitted strands of nylon, DACRON™, or other synthetic fibers, can be constructed with a concave shaped, by various means, including but not limited to: (i) stitching a sheet of fabric to an assembly of internal reinforcing straps, which will impart a concave shape to the completed envelope if the internal straps in the interior regions are shorter than the internal straps around the periphery or the completed assembly; or, (ii) gluing or otherwise bonding the sheets of fabric to the outer components of a stiff or rigid frame which will impart a concave shape to a completed surface. After a sheet of fabric has been coupled to the straps or frame, the fabric can be sprayed with or otherwise coated by a pre-polymeric liquid, which will cure and harden into a thin outer layer which will be impermeable to gas, and which will have the same concave shape as the fabric envelope which underlays and supports the impermeable polymeric film.

It also should be noted that any installation site can have and use more than just one airbarge. For example, additional airbarges can be “stowed” (which can use additional devices, such as a protective shroud or similar cover if desired, without requiring a hangar, building, or fixed roof), and can be activated whenever needed. This can allow the use of various different airbarges having sizes and shapes that are optimized for different wind or weather conditions.

Since an airbarge filled with either hydrogen or helium will constantly try to rise upward, one or more quick-coupling mechanism(s) can be provided, either as a linkage within the main tethering cables, or in some other manner that will allow one or more supplemental tethers to be secured to an airbarge, in a manner which will facilitate handling on the ground.

For example, a set of four or six quick-coupling mechanisms can be suspended beneath an airbarge, at the ends of cables which normally will be kept reeled onto spools that are carried by the airbarge. When a certain type of control signal is received by an electronic control system on the airbarge, the spools can be unreeled, allowing the cables (with a quick-coupling mechanism at the lower end of each cable) to descend to locations where they can be gripped and secured by machinery on the ground (such as a mobile crane-type unit, comparable to a forklift but with a gripping mechanism at the end of an arm that can be extended, retracted, and rotated in any upward direction). When one or more of the quick-coupling mechanisms have been secured by mobile ground units, the airbarge can be towed to a storage site, where any or all of the quick-coupling mechanisms can be secured to one or more anchored devices (such as attachment devices that can travel, under power, along steel rails that are firmly anchored to the ground), to provide a “dock” for the airbarge. The main ground cables (i.e., the cables which connect an airbarge to generators, a train-towing system, or other devices at the ground station) can then be disconnected from that airbarge, and a different airbarge can be coupled to the main ground cables.

Alternately or additionally, other types of mechanisms can be provided, to enable rapid swapping of two or more airbarges at a ground station. For example, a windlass drum or spool which is used to handle a “ground cable” (i.e., a cable between an airbarge and a ground station, as indicated by callout numbers 290 and 292 in FIG. 10), and which is coupled to a rotatable generator shaft during use, can be uncoupled from its generator shaft and moved to a different location, when an airbarge is being temporarily deactivated. As soon as the first windlass drum or spool has been detached from a generator and moved out of the way (presumably with the aid of devices such as connectors which will travel, under power, along rails that have been anchored to the ground), a second windlass drum or spool, loaded with a second “ground cable” that will interact with a second airbarge, can be moved into position. If desired, a first set of windlass drums or spools can be detached from set of generators, and moved out of the way, while the airbarge connected to those cables is a substantial distance away from the ground station, and a second set of windlass drums or spools can be moved into position, and connected to the generators, while that airbarge is close to the ground station and in a “starting position”, ready to commence a pulling stage; that type of approach will maintain a substantial distance and “comfortable separation” between the two airbarges.

A ground-transfer coupling system can enable an airbarge that has completed a pulling stage to be detached from the generator system, and either: (i) winched down to a hangar or other protective device or site; or, (ii) prepared in some manner (such as by partially pumping the buoyant gas into high-pressure tanks, to minimize the projected area and wind resistance of an airbarge in high winds), so that it can ride out a storm while remaining airborne, in a manner comparable to a boat at sea riding out a storm.

As mentioned above, one or more cables can be mounted on spools that are positioned on the bottom side of an airbarge, in a manner which allows the cables to be “unreeled” from the spools so that they will hang down beneath the airbarge. Any such cable can have a grappling or other securing component, as well as a light-emitting, radar-reflective, “homing beacon”, or other signaling device, attached to the bottom end of the hanging cable. If an airbarge is ever released from its ground station, either accidentally or deliberately, such cables (and any devices they carry) can provide a “grappling” mechanism that will allow a helicopter, unmanned drone aircraft, or other suitable type of aircraft to fly beneath an untethered airbarge and “grab” the hanging cable, for use as a towing line. If that approach is used, steps would need to be taken to eliminate any possibility that the hanging cable might become entangled in any rotors, propellers, or similar components of the towing aircraft. Rather than posing an insurmountable obstacle, that would merely pose an interesting challenge, to skilled designers and engineers.

It should also be mentioned that all or any portion of the top surface of an airbarge can be covered with solar electric (photo-voltaic) panels, to generate electric power, which can be used when generated, or stored in onboard batteries or fuel cells until needed to perform a procedure that requires electric power.

FIG. 10 depicts the basic arrangement and connections between an airbarge 200, a spinnaker sail 300, and a ground station 400, when seen from above (i.e., in plan view). The components are not drawn to scale; in actual use, the tethering cables will be longer than indicated by FIG. 7, and the airbarge 200 and spinnaker sail 300 likely will be substantially wider, and have greater surface areas, than the rotatable platform 402 which forms a part of ground station 400.

The plan view of airbarge 200, in FIG. 10, indicates nose end 202, tail end 204, a pair of forward (or front, nose, etc.) wings or fins 212, and a pair of rear (or aft, etc.) wings or fins 212. It also depicts outer vertical fins 224 on both sides of the airbarge, and an inner (or center, medial, etc.) vertical fin 226, which extend the entire length of the airbarge, to help promote laminar flow of wind across the entire length of the airbarge.

The tethering axle 256, which is suspended beneath the bottom surface of the airbarge, is shown in dotted lines; however, to avoid cluttering the drawing, longitudinal rails 230 and 232 traveling frame 250, shown in FIG. 6, are not depicted in FIG. 10.

Tethering cables 290 and 292, which will tether and couple the airbarge 200 to a ground station 400 as shown in FIG. 10, are coupled to the traveling frame 250 via the lateral axle 256. In a preferred embodiment, the two tethering cables 290 and 292 are positioned a substantial lateral distance apart from each other, beneath airbarge 200, by coupling them to the opposing ends of tethering axle 256. The other ends of the two tethering cables are coupled to cable spools 412 and 422, which are spaced apart from each other on ground station 400. This type of “harness” design and placement can provide greater stability than a “single-point” attachment using a single cable; and, a harnessing system of this type can also help rotate ground station 400 (which preferably should be mounted on a horizontally rotatable platform 402) more powerfully, efficiently, and rapidly than can be achieved by a single-cable tethering system, in response to even minor changes in wind direction.

Cable spools 412 and 422 can be referred to as spools, drums, windlasses, windlass drums, winches, winch spools, pulleys, or other suitable terms (which may vary, for different sites, depending on the design of a specific installation). In FIG. 7, to simplify the drawing, they are shown as open cylindrical spools that hold multiple “turns” of cable. In practice, they will be more complex, and can contain devices such as spooling guides that will traverse back and forth across the length of each cylinder, to ensure even windings with no risk of tangling or “catching”.

In addition, cable spools 412 and 422 must be designed to interact with a ground-powered winching mechanism that will allow an airbarge-and-sail assembly to be “reeled in” and pulled close to the ground station, during the retrieval stage of each power cycle. This can be done by any of several means. For example, the cable spools can be coupled to the generator shafts by means of a “ratchet”-type system (i.e., a system which enables powered rotation in one direction, while allowing free rotation in the opposite direction; ratchet mechanisms most commonly use a “gear and pawl” system, but that particular mechanism is not required for a “ratchet” system as used herein, and it also should be noted that “ratchet” and “ratchet” have become equally-acceptable alternate spellings). When the cable spools are being “unwound” (or unloaded, unspooled, or similar terms) during a pulling stage of a power cycle, the rotation of the spools in that direction will act, via the ratcheting system, to forcibly rotate the generator shafts, thereby generating electricity. Each time a retrieval stage of a power cycle is ready to begin, a different ground-powered drive system will be engaged with the cable spools (such as by means of a second ratcheting mechanism, or a gear system or chain drive, which can be engaged when needed and disengaged when not needed), in a manner which will exert winching force on the cable spools, to reel in the cables and “reload” the spools.

Alternately, if the electric generators are designed in a manner that allows them to also serve as electric motors (i.e., if their shafts will undergo powered rotation when current is driven through their coils), the only additional mechanisms that will be required would involve electric switches, which will allow any number of power cycles to be carried out by shifting the generator-motor units back and forth, between: (i) generator mode (i.e., which will convert mechanically-powered rotation into electric current) during each pulling stage; and (ii) motor mode (i.e., which will convert electric voltage and current into mechanically-powered rotation) for each retrieval stage.

The development of generator and motor systems which can shift back and forth between a wind-driven pulling operation, and a ground-powered retrieval operation, is well within the skill of the art, and any suitable mechanism can be used, based upon the size, power requirements, and other operating parameters of a specific installation. The factor which must be kept in mind, when designing and assembling any such system, is that: (i) the wind-driven pulling operation, which will occur when the spinnaker sail is fully deployed to catch the wind, will generate large pulling and tensile forces; and, (ii) the retrieval operation, when the spinnaker sail has been shifted into a generally flat and planar of material which will flap and “luff” in the wind like a flag or banner, should minimize any resistive forces, so that the amounts of energy, power, and work which will be required, to perform the retrieval operation, will be minimized. The difference between: (i) the large pulling forces that will be created and provided by an airbarge-and-sail combination, during a pulling stage, and (ii) the much lower “power cost” that will be required to reel in an “idled” sail that is flapping and luffing like a flag, provides the foundation for this invention, and enables it to provide a “net power out” method for generating electric power.

In FIG. 10, paired generators 414 and 416 are driven by cable spool 412, while paired generators 424 and 426 are driven by cable spool 422. Each generator is schematically depicted by positive and minus signs; in actual use, they likely will generate alternating current (AC), rather than direct current (DC).

If a large tensile load is imposed on the “free end” of a rotating shaft which extends out from a generator, the load can generate a type of force and stress referred to by mechanical engineers as a “bending moment” (where “moment” refers to a type of force, rather than a moment in time) on the generator shaft. Over time, that type of force and stress can bend, warp, or otherwise damage a rotating shaft, and any bearings which support and constrain the shaft. To prevent that type of damage, a system should be designed to avoid imposing “bending moments” on the free ends of any generator shafts. That can be accomplished by various means, such as placing the previously free end of a shaft within a rotating wheel or gear that is anchored to the same base or other structure which supports the generator; if this is done, the tensile force will be exerted on a internal segment of shaft that is supported and reinforced at both ends, rather than on a non-reinforced “free end” of a shaft. Similarly, the same type of shaft-reinforcing means can be provided by placing each cable spool between two generators, both of which will be driven by a single cable spool. As a third alternative, either of the “paired” generators shown in FIG. 10 can be replaced by an electric motor that can be used to provide power for the retrieval stage of each power cycle.

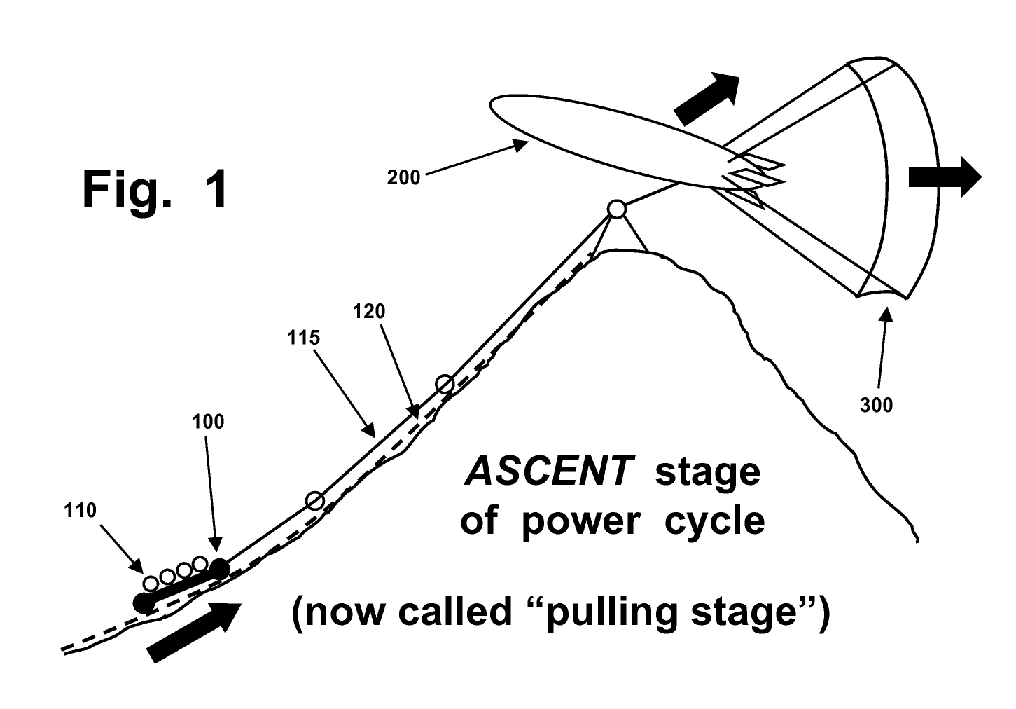

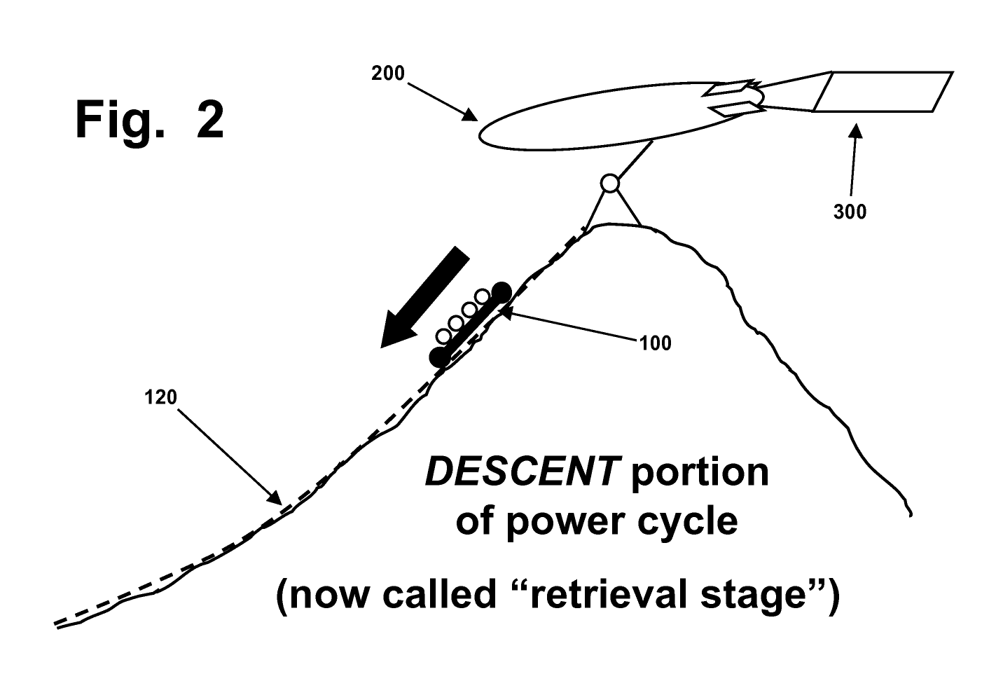

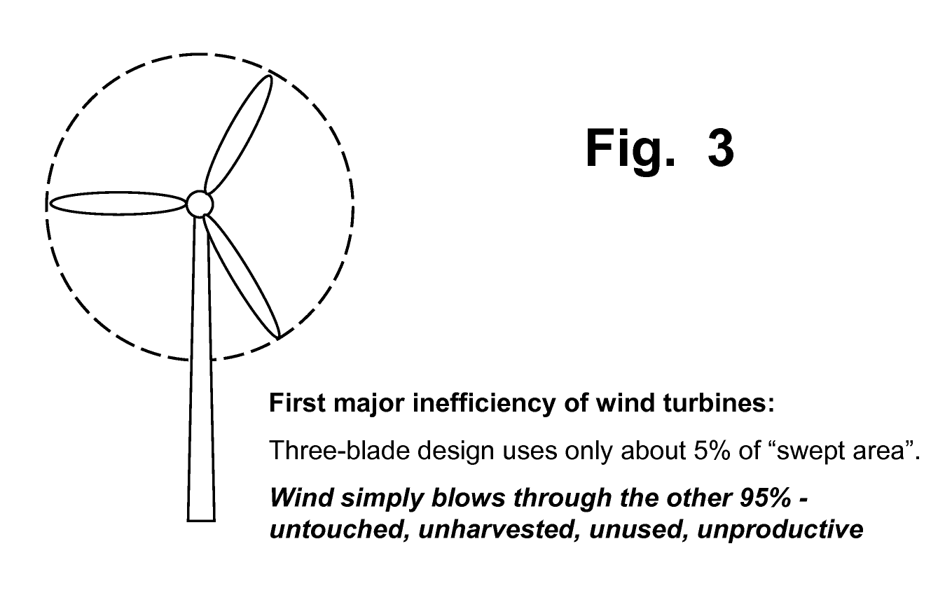

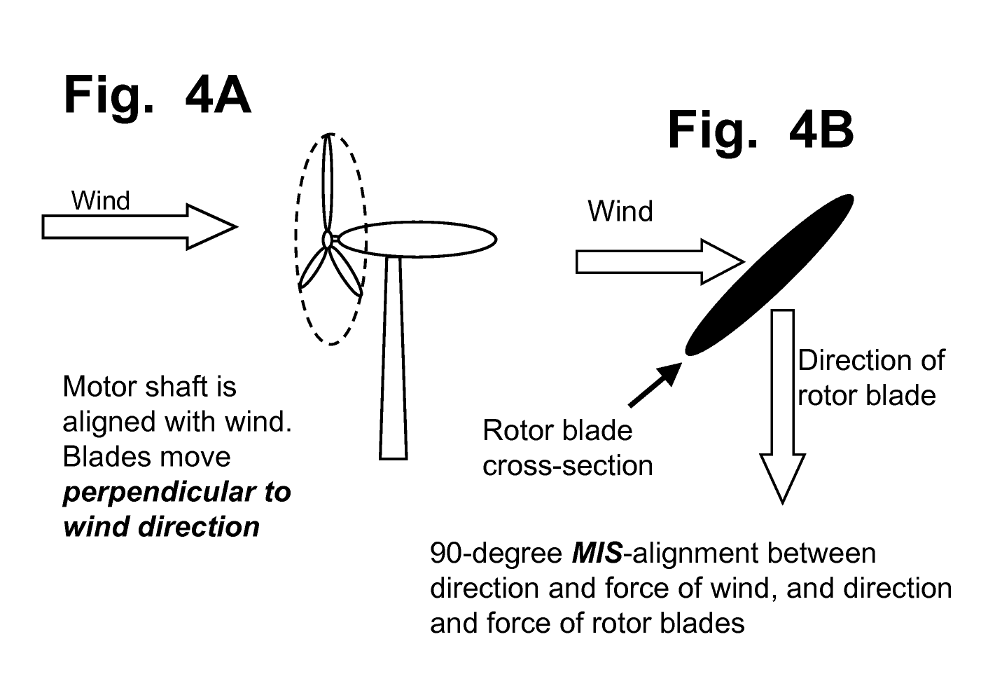

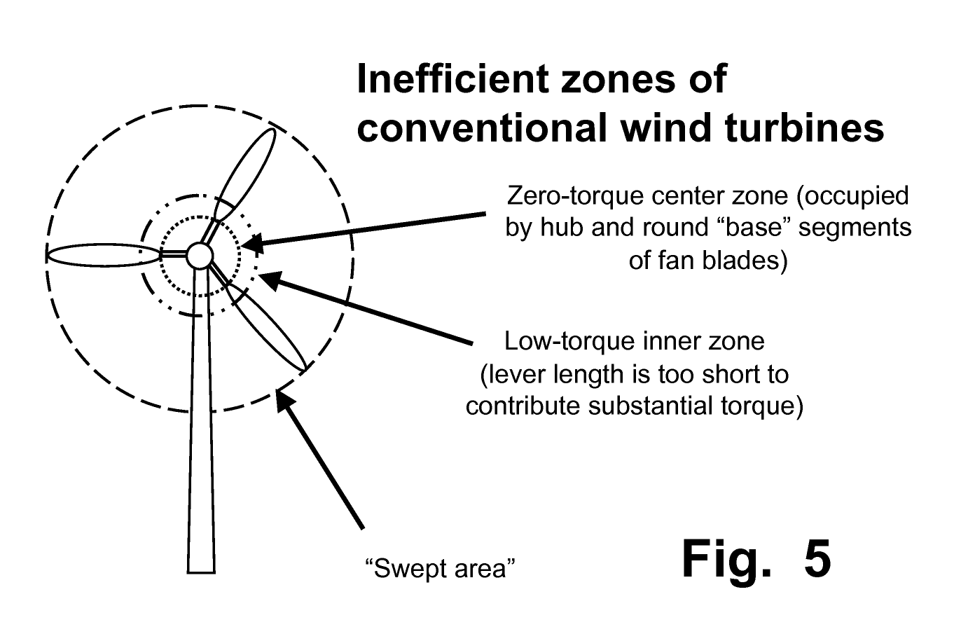

As mentioned above, the primary invention herein resides in airbarge-and-sail pulling systems that will create large wind-driven pulling forces. This invention is not tied or limited to any specific type of ground station, generator system, or other device or assembly for converting wind-driven pulling force, into electric power or other work output. Instead, a “towed train” system as depicted in FIGS. 1 and 2, and a “direct pull” generator system as depicted in FIG. 10, are merely examples, which illustrate that systems can indeed be created, using well-known types of devices, which can convert wind-driven pulling power into electric power or other useful power outputs.

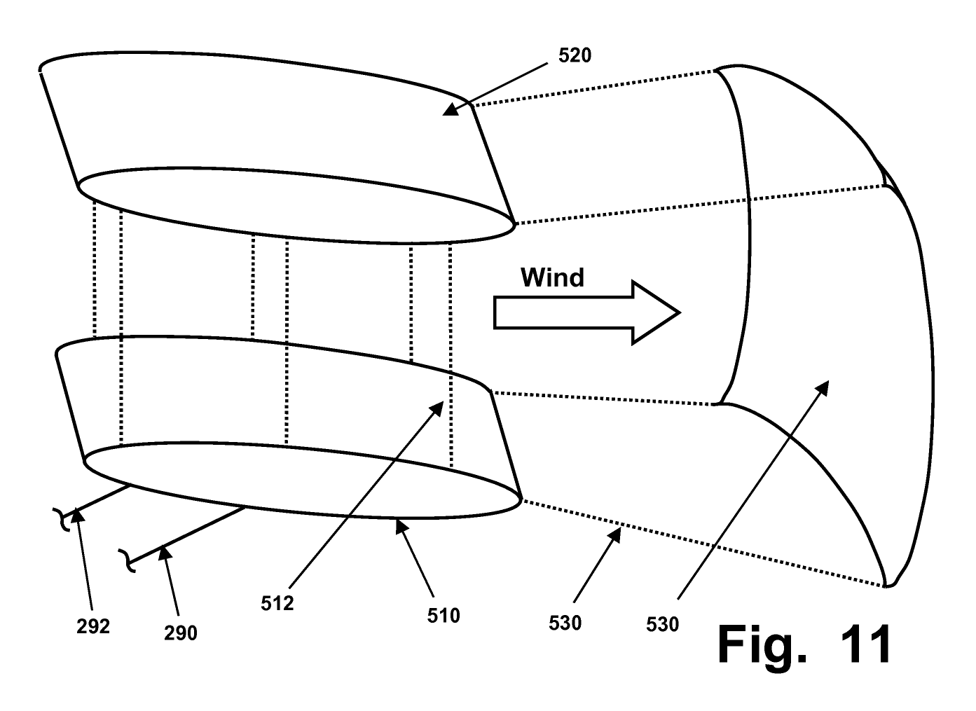

Two or more airbarges can be flown together, as a coupled unit, such as in an array (or stack, column, etc.) that is held together by vertical or slanting cables which couple the airbarges to each other. If this approach is used, the coupling cables must be designed and placed so that any tensile forces which might damage the envelope material are coupled to internal frames, straps, or similar members that are designed to withstand such loads, rather than to the envelope material. For example, FIG. 11 depicts airbarges 510 and 520 (shown in a simplified manner, with no fins or other external appurtenances, to prevent clutter in the drawing), coupled to each other via coupling cables 512, while a spinnaker sail 530 is coupled to both of the airbarges, via cables 532. Wind can blow through the vertical space or gap between the two airbarges, and if desired, the relative angle between the main horizontal planes of the two airbarges 510 and 520 can be controlled, to create a funneling effect for the wind. If this type of arrangement is used, the spinnaker sail can be positioned relatively close to the tail ends of the airbarges, or it can be directly coupled to the airbarges, in a manner which effectively will incorporate two or more airbarges and one or more sails into a single unit. Furthermore, the lateral edges of such a spinnaker sail can be extended out beyond the edges of the airbarges, by means such as cables, spreaders, etc.

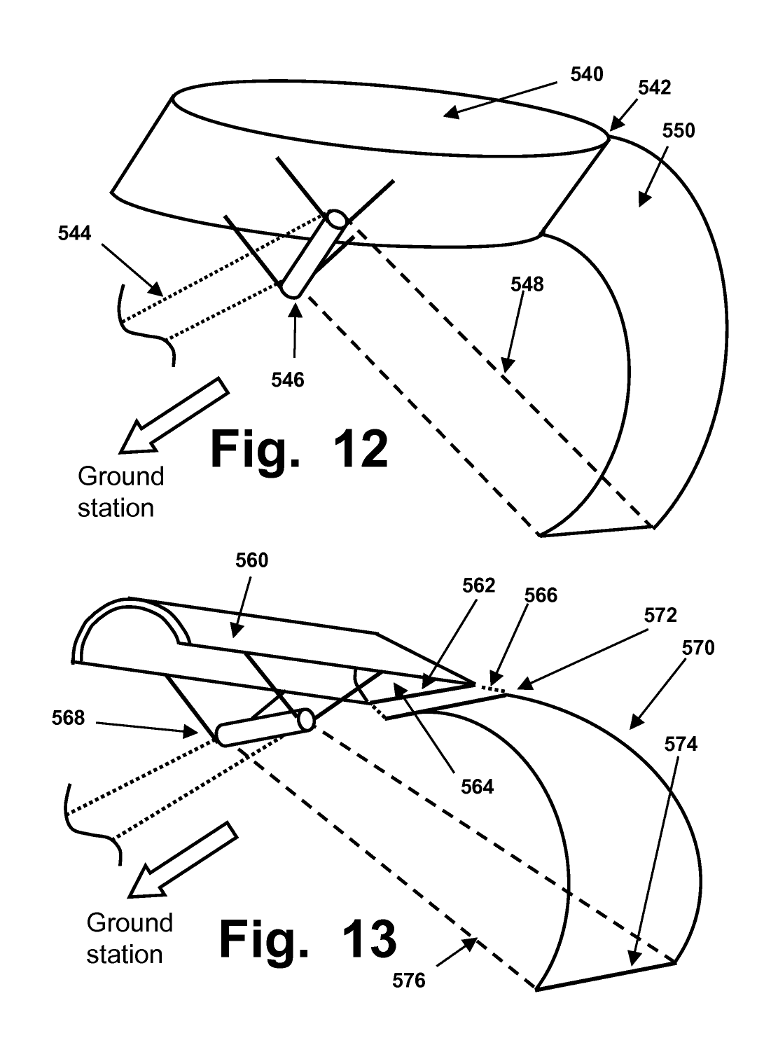

On the subject of spinnaker-type sails that are coupled directly to the tail end of an airbarge, FIGS. 12 and 13 indicates two arrangements which hold substantial promise, and which will merit computer simulation work and scale-model testing, to determine whether systems designed along these lines can generate electric power in more economically-efficient ways than other designs, when various specific types of airborne pulling systems (which can vary widely, in terms of size, expense, power output, etc.) are matched up with various wind speeds and weather conditions.

FIG. 12 depicts a relatively wide airbarge 540 as described above (illustrated in a simplified manner, which omits the vertical fins, bottom rails, and other appurtenances in order to avoid cluttering the drawing), with a spinnaker sail 550 coupled directly to the tail end 542 of the airbarge 540, along the entire width of the airbarge 540. A set of barge-tethering cables 544 (which will couple airbarge 540 to generators, a train unit, or other equipment at a ground station) is shown, coupled to a transverse traveling axle 546.

The same transverse axle 546 is also shown as a coupling point for sail cables 548; however, it must be noted that sail cables 548 will require an independent control mechanism which can perform two different functions: (1) retracting (shortening) cables 548 at the start of each pulling stage, to place them under tension; and, (2) releasing and extending cables 548, at the start of each retrieval stage. In general, refraction of those cables would require a large amount of power, if performed while the sail is deployed and filled with wind. Therefore, means preferably should be provided for refracting cable segments 548 while spinnaker sail 550 is under relaxed or “luffing” conditions, during a retrieval stage.

For simplicity of illustration, rectangular-shaped spinnaker sails 550 and 570 (which have been blown into curved shapes, by the wind) are shown in FIGS. 12 and 13. In practice, other shapes can provide better performance, by eliminating “easy exit” pathways that would allow pressurized air to escape from a spinnaker sail without performing a due and proper amount of useful work. Accordingly, a dome-type shape (or at least a shape with constricted side edges, having an overall shape of a type that could hold a substantial quantity of liquid, if facing upward) will generally be preferred, whenever a spinnaker sail is fully deployed and filled with wind. For example, sails 550 or 570 can have a generally round (or pentagonal, hexagonal, octagonal, etc.) dome-type parachute shape, with one edge coupled to the tail end of an airbarge. As mentioned previously, the overall shape of a spinnaker sail, when deployed and filled with wind, will be established and controlled by reinforcing straps, and possibly by stiff brace-type components (which can be called battens, spreaders, crossbars, cross-members, etc.).

FIG. 13 depicts an embodiment in which a gas-filled airbarge 560, which has a generally wide and flat shape, has been either manufactured, or partially rolled up, into a “trough” or “half-pipe” shape which opens downward. That shape will create a distinct flow channel, which will enable wind blowing beneath the airbarge to generate additional lift. The tail end 562 of airbarge 560 has been provided with a sloped panel 564, to generate even more lifting and pulling power, and to help direct the wind which exits the tail end 562 of airbarge 560 into spinnaker sail 570, which has an upper edge 572 and a lower edge 574.

The tail end 562 of curved airbarge 560 is coupled to the upper edge 572 of spinnaker sail 570, by means of short cable segments 566. This arrangement will create a gap between the airbarge and the sail. In some situations, that type of gap may be beneficial, even if it allows some escape of pressurized air along unproductive and non-optimal pathways, if it can enhance the ability of an operator to: (1) control the airbarge portion of the pulling assembly, in ways which will optimize the airbarge's performance as a lifting device; and, (2) control the sail component of the assembly, in ways which will optimize the sail's ability to generate large pulling forces.

As mentioned above, spinnaker sail 570 is shown with a rectangular shape, for simplicity of illustration; in practice, it likely will have more of a domed shape. Lower edge 574 of sail 570 is coupled to transverse axle 568 (which is mounted beneath airbarge 560) by means of retractable and extendable cables 576, which will be alternated between a retracted (or tight, tensile, etc.) mode for each pulling stage, and an extended (or relaxed, released, etc.) mode for each retrieval stage.

FIG. 14 depicts an airbarge 600 which has been provided with a set of four propeller engines 610 positioned around the periphery of the airbarge. Such engines can provide an airbarge with greater maneuverability, and can render it well-suited for alternate uses, such as for lifting and transporting heavy structures, such as used in road or building construction, utility repairs, or cleanup after a disaster (and possibly for passenger transport as well, as discussed in more detail in parent application Ser. No. 12/390,503). This arrangement would be similar, in some respects, to the SKYHOOK™ class of buoyant aircraft, developed by Boeing.

In one preferred embodiment, if the engines 610 burn liquid fuel (rather than being powered by electricity), each engine can be mounted at the end of a horizontal shaft 620 that can be rotated through an arc of 270 degrees. This will enable the thrust from each engine to be pointed in any of the orthogonal directions (i.e., rear, up, forward, and down), while avoiding various complications (mainly involving fuel flow) which would arise if an engine were designed to rotate endlessly around a complete circle. Alternately, if the engines are designed to rotate reversibly (i.e., either clockwise or counterclockwise, when seen from in front of the rotating blades), a 90 degree angle of rotation for the mounting shafts 620 would be sufficient.

Alternately, if the propeller engines 610 are driven by electric power, the electric motors can be designed for dual usage as either motors or generators, and the propellers can be used as electricity-generating wind turbines, when not required for maneuvering the airbarge.

FIG. 14 also provides a perspective view of vertical side fins 602 and 604 and center fin 606, all of which extend the entire length of the airbarge 600. Those fins help create “bounded channel” shapes on both the top side and the bottom side of the airbarge. As discussed below, a “bounded channel” shape can help capture and direct the flow of wind across an airbarge, in a manner which can make efficient use of the force and power of the wind as it passes over or under the airbarge. These fins can help generate lift during each pulling stage, and can help a buoyant airbarge descend with minimal power consumption, during each retrieval stage.

It should also be noted that, if propeller engines are provided as part of an airbarge as described herein, they can also provide ways to help ensure that: (i) there will be fewer (if any) “upsets” and problems, such as a 360-degree “roll” by an airbarge, which would create a twist in its ground cables; and, (ii) if any such upset or problem occurs, the airbarge will have a means for correcting the problem, without major difficulties or extended down-time.

When the airbarges disclosed herein are described in language suited for a patent claim, certain features emerge as being critical to the design and operation of these types of lifting devices. Briefly, any such airbarge will be a “lifting device” filled with buoyant gas (i.e., hydrogen and/or helium), which will require a gas-impermeable envelope (i.e., a thin and flexible “outer skin”, illustrated in the drawings as a top, bottom, or side surface of an airbarge) which will be affixed to a “load-bearing support structure” (which can be an internal frame made of stiff members, an assembly made from strong but flexible straps, etc.). Because of the shape that will be required to “fly” any such airbarge in a controllable manner, it will require a nose end, a tail end, and a wide streamlined body shape that will generate both:

a. lifting force, when the lifting device is flown into wind at an ascending pitch, with the nose end higher than the tail end; and,

b. descending force, when the lifting device is flown into wind at a descending pitch, with the nose end lower than the tail end.

In order to distinguish these types of airbarges from unrelated or non-anticipating prior art involving other types of airborne devices (such as, for example, toys, models that were created only for testing or simulation purposes, etc.), the claims herein also include limitations such as, “designed for use at an elevated altitude while coupled to an airborne spinnaker sail”, and, “wherein said lifting device encloses sufficient volume within said envelope to enable the lifting device to vertically lift a suspended mass weighing at least 1 ton when said envelope is filled with buoyant gas”.

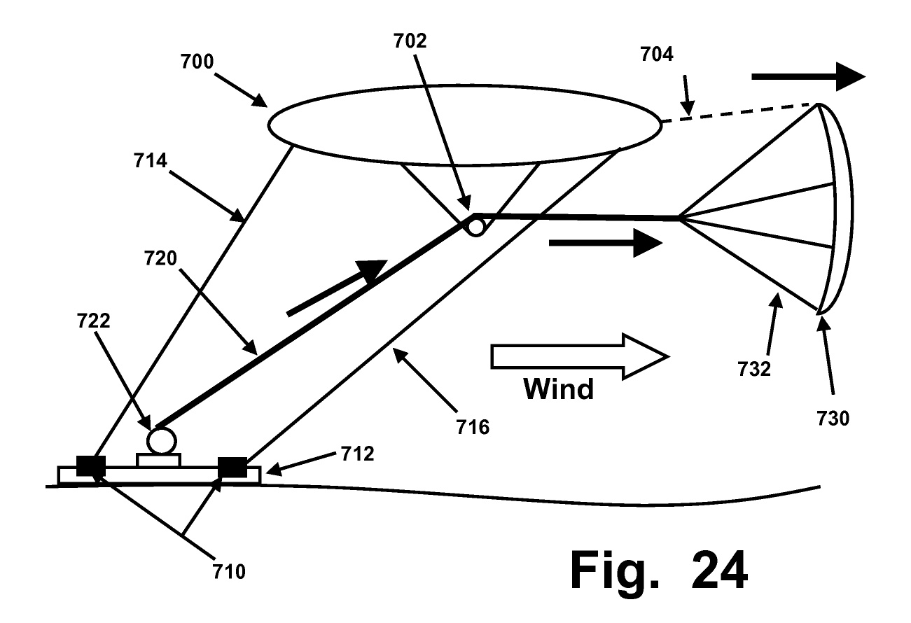

Another crucial aspect of any airbarges which will travel horizontally, along with a spinnaker sail, is that the ground cables and the sail cables must be provided with connection means that will allow the “pitch” of an airbarge (i.e., its angular rotation and positioning, about an imaginary horizontal axis with a left-to-right (i.e., transverse) orientation, regardless of how much tensile (pulling) force is being imposed on either set of cables, at any given moment. When stated in claim language, this requires that this type of moving lifting device (as distinct from a “stationary” lifting device, as described below and illustrated in FIG. 24) must be provided with:

(i) ground-cable coupling means which enable the lifting device to be securely attached to a plurality of cables that will remain coupled to at least one power-generating device which will remain at a ground station during a sequence of power-generating cycles;

(ii) spinnaker-cable coupling means which enable the lifting device to be attached to a plurality of cables that will be coupled to an airborne spinnaker sail, when the lifting device is in use; and,

(iii) pitch control means which enable the lifting device to be controllably rotated, about an imaginary transverse horizontal axis, into an ascending pitch during a pulling stage of each power-generating cycle, and into a descending pitch during a retrieval stage of each power-generating cycle, regardless of how much tensile force is being applied to said ground-cable coupling means or said spinnaker-cable coupling means on said lifting device.

### Spinnaker Sails and Spreader Devices

As defined in the Background section, an airborne spinnaker sail is a sail that is: (i) coupled to a buoyant airbarge, and used to convert wind energy into mechanical force; and, (ii) designed to be deployed in a manner that will cause the largest “projected area” of the sail to be oriented perpendicular to the direction of the wind, so that the sail will “catch” the wind, and will be opened up and filled by the wind to the fullest extent allowed by the construction of the sail, in a manner which will generate maximum pulling force in the same direction that the wind is blowing. As described in the Background section, to reduce the temptation for potential competitors to sidestep a set of patent claims by selling airborne spinnaker sails that will operate at a slightly slanted angle (which could provide, for example, 99% or 98% efficiency rather than 100% efficiency, and which would allow an operator to easily correct the non-optimal angle), an 80% standard has been arbitrarily selected as a “benchmark” test, to determine whether a “quasi-spinnaker” sail falls within the definition of “airborne spinnaker sail” as set forth herein.

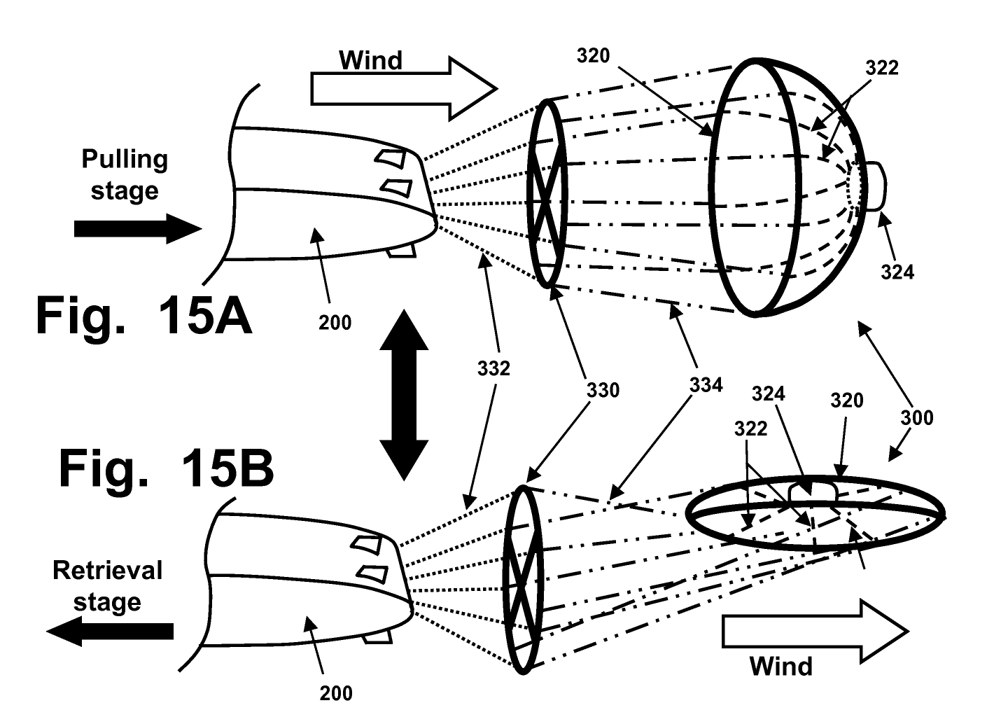

An example of an airborne spinnaker sail 300 is depicted in FIG. 15, which includes panel 15A (showing sail 300 in its deployed mode, where it has “caught” the wind and is “facing into” the wind, during the pulling stage of a power cycle), and panel 15B (showing sail 300 in a flattened mode, during a retrieval stage). When deployed and open, sail 300 has a domed shape, comparable to a round parachute; that shape is established and controlled by a circumferential strap 320 around its periphery, and by a set of reinforcing straps. Radial straps 322 are indicated by dashed lines, in FIG. 15A; they are shown more clearly, and “concentric” or “annular” reinforcing straps 366 also are shown, in FIG. 18. FIG. 15 also depicts a strap retractor 324, described below.

A spreader device 330, which can be used to help ensure that sail 300 will be deployed and retrieved properly, is positioned between airbarge 200 (coupled to it by cables 332), and sail 300 (coupled to it by cables 334). This spreader device 330 can be made in various ways, such as by assembling it from bars or struts made of aluminum, graphite, or other materials with high strength-to-weight ratios. It should be noted that spreader device 330, or various other types of devices that can be positioned between an airbarge and a sail, can be used to help protect the sail during high winds, and can thereby extend the range of wind speeds at which airborne spinnaker sails can be deployed, for generating electric power. Such devices are described in more detail below.

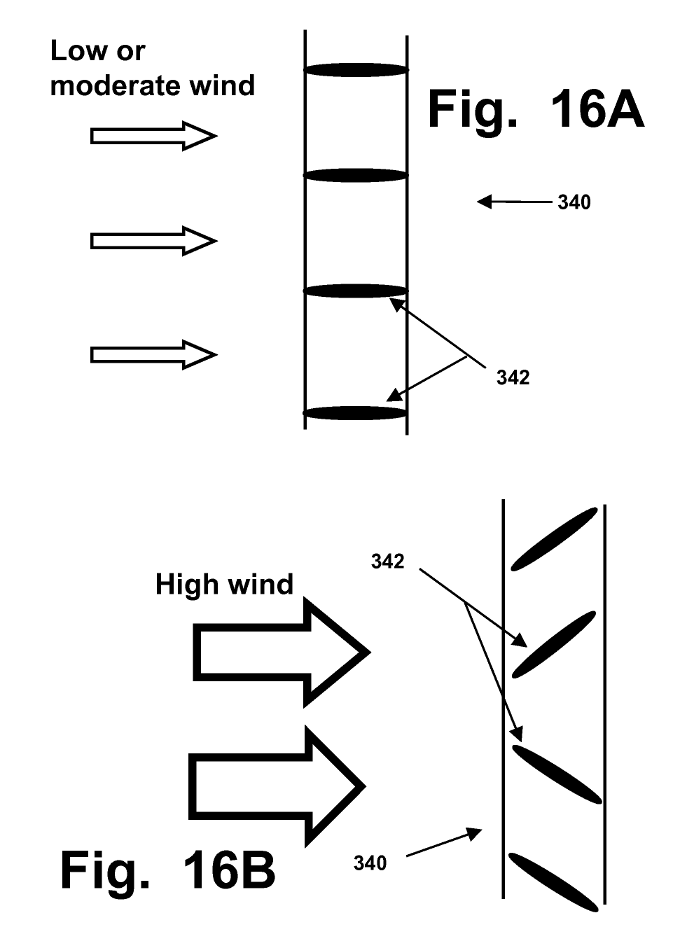

Panel 15B, which is also part of FIG. 16, depicts sail 300 while it is collapsed (or retracted, furled, or similar terms) into a generally flattened and/or planar shape, which will allow it to “luff” in the wind (in a manner comparable to a flag or banner) without generating strong resistive force, during each retrieval stage. To shift sail 300 into that configuration, the radial reinforcing straps 322 are retracted into the retractor device 324, which will require a power supply, and which is mounted in the center of sail 300, in the arrangement shown in FIG. 16.

If desired, other configurations for mounting and operating retractor device 324 can be used. In particular, in one preferred embodiment, the outer rim 320 of sail 300 can be coupled directly to spreader device 330, and retractor device 324 can be mounted at any desired location on spreader device 330. This would allow a set of retractor cables to travel across a number of small pulleys, wheels, or similar devices mounted at various locations around the spreader device, so that when the retractor cables are pulled into retractor device 324 (driven by the rotation of spools or similar devices), the sail 300 will be converted into a flattened shape more effectively and with better leverage than can be achieved by a refractor device coupled to the top of a dome.

Alternately, different devices and arrangements can be used to convert a spinnaker sail from a “deployed” shape or status (i.e., with maximal projected area facing into the wind, to generate maximal wind-driven pulling force) into a “collapsed” or “retrieval” (or similar terms) shape or status (i.e., with minimal projected area facing into the wind, to allow the sail to be pulled back to its “starting point”, so that the next power cycle can be commenced). One such arrangement can emulate the shape and mechanism of an umbrella, as it is put into the positions commonly called “up” or “open” (when spread out, while in use), or “down” or “closed” (which not in use). In this arrangement, a cable attached to the center point of a spinnaker sail can be kept in tension, while the cables around the periphery of the sail are released from tension. This would allow the sail to shift into a “closed umbrella” configuration, pointing upwind, which would allow low-power towing of the sail back to a position where it is ready to start the next power cycle.

Subsequently, when the next pulling stage is ready to begin, a powered mechanical spreader device can be used to initiate a symmetric opening operation, for the spinnaker sail. That powered operation would need to be started only briefly; as soon as the interior of a dome-shaped spinnaker sail begins to fill with wind, it will quickly shift into a fully open and deployed shape. Accordingly, any such mechanical spreader preferably should contain damping devices, to prevent a spinnaker sail from “snapping open” too quickly, in ways which might impose dangerously high peak stresses on the sail and its reinforcing straps.

As indicated in FIG. 15, spreader device 330 will be positioned between an airbarge and a spinnaker sail. If designed to do so, it can help protect the sail during high winds. One example of such a device is schematically depicted in FIG. 16, which includes panels 16A and 16B, which depict a cross-section of a portion of a spreader device 340. A number of internal struts 342 (shown in cross-section; they also can be called slats, louvers, or similar terms) are provided within a frame or outer member which surrounds the spreader device 340. Internal struts 342 have elongated cross-sections, which can be rotated into a parallel streamlined arrangement, for minimal wind resistance, when winds are low or moderate. If winds increase to levels that would be difficult for a spinnaker sail to handle, the struts can be rotated into slanted angles that will cause the spreader device 340 to absorb a substantial amount of the wind force. That can create a corresponding decrease in the wind forces and stresses that will be imposed on the spinnaker sail, which trails the spreader device, on its downwind (or “leeward”) side. Stated in other words, if a spreader device is suitably designed, it can effectively divide, between two different devices, the forces and stresses that will be imposed on the system by strong winds, thereby shifting to the spreader device some portion of the stresses that otherwise would be imposed on the spinnaker sail.

Alternately or additionally, an adjustable device having a rounded conical shape, or a sloping pyramidal shape, with its point (apex) facing into the wind and with a width and slope that can be controlled and altered as needed, can be positioned between a lifter, and a spinnaker sail. In low or moderate winds, its size (i.e., the projected area which is impacted by wind) can be minimized, during high wind conditions, it can be expanded, to deflect wind away from the spinnaker sail.

FIG. 17 depicts another option for coupling a spinnaker sail to an airbarge, using a spreader device 330. In FIG. 17, which contains panels 17A (showing airbarge 630 in a “nose up” angle, for a pulling stage) and 17B (showing airbarge 630 in a “nose down” angle, for a retrieval stage), the nose 632 and tail end 634 of airbarge 630 are identified by callout numbers, and an imaginary “x” also is shown on the side of the airbarge, at the location of the “centroid” 639 (which can also be called the center of gravity, or center of buoyancy) of the airbarge. A large and strong reinforced axle 640 passes through airbarge 630 in a transverse (left-right, port-starboard) direction, at a location which, in FIG. 17, is roughly at a halfway point between centroid 639, and tail end 634. A “halfway” location between the centroid and the tail, is regarded as suitable and adequate; that placement might be improved somewhat, and optimized, by computer modeling and scale model testing. The axle 640 emerges from both lateral sides of the airbarge 630, and it controls the rotation of an arm 642 which can rotate through an arc as shown in panels 17A and 17B of FIG. 17 (a symmetrically identical arm is located on the opposing side of airbarge 630). The rotatable arm 642, shown in a raised position in panel 17A and in a lowered position in 17B, will truncate at arm end 644, which will provide coupling points for a set of cables 332, which will couple spreader device 330 to airbarge 630. An additional set of cables 334 (shown in truncated form) will couple the spreader device 330 to an airborne spinnaker sail (not shown in FIG. 17).

If the vertical height (altitude) of the arm end 644 is the same as the vertical height of the centroid 639 of airbarge 630, at any particular time during a power cycle, then the horizontal pull of the spinnaker sail, exerted on the airbarge via the inter-positioned spreader device 330, cables 332, and arm end 644, will not impose any significant rotational force (i.e., torque) on the airbarge. Indeed, the positioning of that type of force, near the tail end of an airbarge, can help stabilize the airbarge and minimize any unwanted pitching motions (and can also help minimize any unwanted yaw, sway, heave, roll, or surge motions, as well).

That same principle applies to the positioning of the arm end 644 during a retrieval stage, as shown in panel 17B. As the airbarge 630 rotates from a “nose up” position into a “nose down” position, its tail end 634 will rise higher. Accordingly, transverse axle 640 is rotated in a clockwise and synchronized manner, so that arm end 644 will remain horizontally even and level with centroid 639, as airbarge 630 rotates. Similarly, when a retrieval has been completed and it is time to rotate the airbarge into a nose up position again, the axle will be rotated counterclockwise, to keep arm end 644 level with centroid 639.

For simplicity of illustration, the lever arm 642 is shown as being relatively short, so that arm end 644 does not extend beyond the tail end 634 of airbarge 630. If desired, the lever arm can be long enough to “clear” the tail end 634, in a manner which would allow that assembly to support (and to control the elevation of) an attachment device which can extend across the entire width of the airbarge.

If an arrangement as shown in FIG. 17 is used, the spinnaker sail will be positioned downwind of the airbarge, and the requirement that the wind must first flow around the airbarge, before reaching the spinnaker sail, will reduce, to some extent, the efficiency of the spinnaker sail. That factor needs to be recognized; however, certain offsetting factors apply, and must also be recognized. First, the “total projected area” of the entire traveling assembly (including the airbarge, spreader, and sail), rather than the projected area of any single component, will be the primary factor which establishes and affects the amount of pulling force that will be exerted on any cables which will be driving generator shafts or otherwise providing usable work input to a ground station. Second, there is no fixed limit to the distance or spacing which can be provided between an airbarge and a spinnaker sail, and if an operator desires to increase that distance, steps can be taken to do so, such as by providing one or more relatively small buoyant lifters (such as a relatively small balloon, comparable to a weather balloon but with a streamlined shape) to support a spreader device, a section of cable length, etc. Thirdly, it would be feasible and practical to mount a “spoiler”, baffle, or similar air-directing device which will span the distance between the left and right (port and starboard) arm ends 644, if those arm ends are positioned to “clear” the tail end of the airbarge. That type of device can help reestablish laminar (or at least “almost normal”) wind flow into the spinnaker sail, while also increasing the amount of pulling force that the airbarge can contribute, for power generation.

FIG. 17 also depicts an alternative coupling mode for cables 290 and 292, which couple the airbarge to a ground station (second cable 292 is directly behind cable 290, in the side views shown in FIGS. 17A and 17B). In this arrangement, forward struts 294 and aft struts 296 are suspended beneath airbarge 630, to support fore and aft transverse struts 295 and 297. A set of strong chains 293, with each chain having multiple parallel links (comparable to the timing chain in an automobile engine), is suspended beneath transverse struts 295 and 297, with enough extra chain to enable the chain segments to flex and shift as indicated in FIG. 17. A parallel set of powered gears 298, coupled to each other via a transverse traveling axle 299, and with each gear 298 interacting with one of the multi-link chains, will travel in alternating fore and aft directions. As the gears rotate clockwise (when seen from the direction shown in FIG. 17A), they will carry the transverse traveling axle 299 toward the tail end of the airbarge 630. As axle 299 moves toward the tail end 634, the airbarge 630 will rotate in a nose-up direction, in a manner which seeks to keeps centroid 639 (i.e., the center of buoyancy for the airbarge 630) directly above the downward-pulling cable attachment point at all times, as depicted in FIG. 17A. Conversely, when the powered gears 298 rotate in the opposite direction and carry the transverse axle 299 toward the nose end 632, they will effectively pull the nose downward, in a manner which will continue to attempt to keep centroid 639 (i.e., the center of buoyancy for the airbarge 630) above the downward-pulling cable attachment point, as depicted in FIG. 17B.

Accordingly, this cable attachment mode operates in a manner comparable to the traveling axle arrangement shown in FIG. 6, but without a requirement for any longitudinal rails mounted beneath an airbarge.

In addition to providing one or more spreaders, spoilers, or other devices between the airbarge and the sail, to help limit and control stresses on a spinnaker sail during high winds, the sail itself can be provided with various means to limit such stresses during high winds. Three such methods are disclosed herein, and these methods can be used in combination.

One method involves only partial deployment of a limited area of a spinnaker sail, depending on wind speeds. On sailboats, spinnaker sails typically are “furled” and stowed (stored) by reeling them onto long rotatable rods, which act as spools for the fabric of the sail. Similar mechanisms can be used to provide a means for deploying an airborne spinnaker sail only partially, so that its projected area, when deployed, can be limited and controlled during high winds. Alternately or additionally, systems can be designed which will limit and reduce the deployment lengths of selected reinforcing straps on a spinnaker sail, during pulling stages that will be performed in high winds. In general, such systems should be designed to perform any such reductions in sail area and/or strap lengths, during a retrieval stage of a power cycle, when resisting forces will be minimal.

A second method for protecting an airborne spinnaker sail against high winds (and for extending the range of wind speeds that can be tolerated and “harvested” by such sails) can use a set of vents, passing through the fabric of a sail, which can be kept closed, during low or moderate winds, and which can be opened to controllable distances, as wind speeds increase. In general, any such vents should be distributed in an even and symmetric manner, around the surface of a spinnaker sail. FIG. 18 depicts four such vents 362, in a round spinnaker sail 360. For simplicity of illustration, only four vents are shown in FIG. 18; in a large sail, well over a dozen might be used. Also for simplicity, FIG. 18 depicts a set of 8 radial reinforcing straps 364, an outer reinforcing strap 365 which surrounds the entire sail 360, and a set of “annular” or “concentric” straps 366 (the outer strap 365 can be regarded as one of the concentric straps 366). Together, those straps illustrated in FIG. 18 divide the surface of sail 360 into 40 segments (or blocks, panels, etc.). In a large sail with a round projected area, the number of such straps is likely to be larger, and the number of segments created and bounded by the straps will be larger; in addition, a number of “partial radial” straps (which will extend from the outer rim, only part of the way toward the center of the sail) likely will be provided around the periphery of a sail, to prevent the outer segments from becoming exceptionally large and vulnerable.

Accordingly, a vent 362 can be created by: (1) sewing or otherwise securely coupling the outermost edge of a segment of fabric, to the outermost concentric reinforcing strap which bounds that segment; and, (ii) coupling the inner edge of that fabric segment to an inner concentric reinforcing strap, by means of an adjustable, responsive, or controllable coupling mechanism which will allow the inner edge to open a suitable distance, when appropriate.

Any of several candidate coupling mechanisms can be used, such as short segments of cable or chain which are governed by gears and/or clamping mechanisms coupled to electronic controls. If high winds are detected (or forecast, in the near future), a gear-and-clamp mechanism can allow partial release of the cable or chain segments, which normally will hold the vents closed. That release of limited lengths of cable or chain, shortly before or during high winds, will not require any energy consumption or work input, since it will be driven by wind power, and each such adjustment of the vent positions will place them into a position that will be used for multiple power cycles. Subsequently, after wind speeds have returned to moderate levels, the cable or chain segments can be retracted again, to close the vents, by small electric motors or similar devices. That retraction step can be done during a retrieval stage, when the cable or chain segments will not be under tension, to minimize any energy input that will be required to return the vents to their closed positions.

Alternately or additionally, various types of spring systems can be used to help control the vents in a spinnaker sail. The spring mechanisms can be made of metallic components that will not be degraded by UV radiation, rather than elastomeric polymers; and, they can be designed to keep the vents either fully closed, or opened to a level that is controlled by a cable-clamping mechanism as described above, unless and until a force level which exceeds a certain threshold is reached. Accordingly, spring-type vent controls are well-suited for helping spinnaker sails withstand strong gusts of wind, either on a stand-alone basis, or in conjunction with other vent-control mechanisms.

Various other types of vent control mechanisms can be evaluated, if desired. For example, wires that will extend or contract in a reversible manner, depending on a factor such as temperature, can be made from various alloys (such as certain zinc-copper blends). The lengths of such wires can be controlled by passing electric currents through the wires. These types of wires are well-known, and are widely used as “muscle wires” in robotics and toys. If desired, they can be adapted for controlling vent openings, in a spinnaker sail.

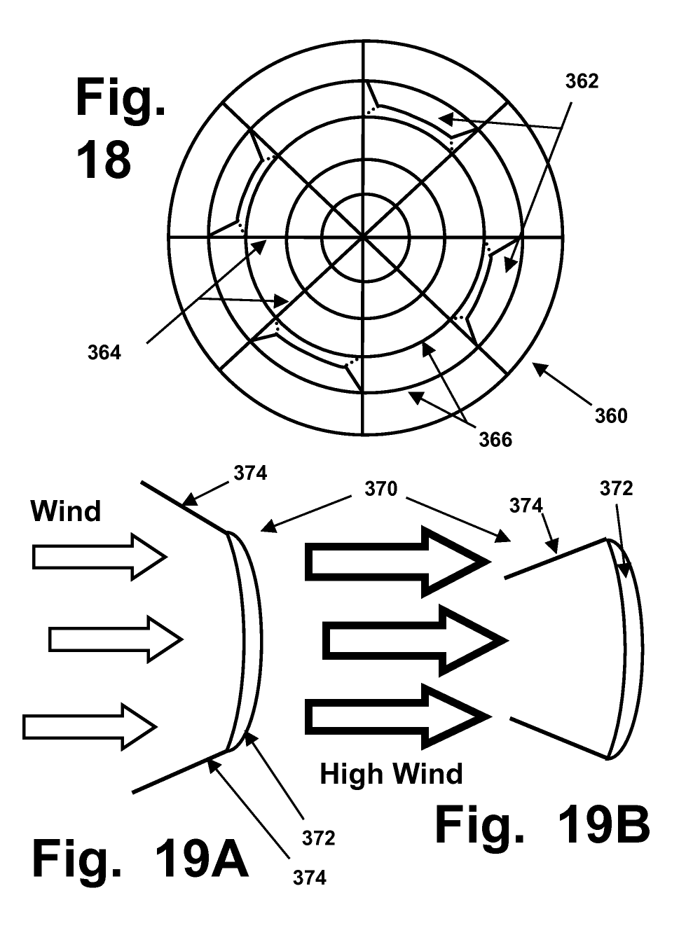

Alternately or additionally, one or more movable segments or flaps of fabric that are attached to the outer perimeter of a spinnaker sail, can be positioned in any of several alternate arrangements, depending on wind speeds at any particular time. This concept is depicted schematically in FIG. 19, which includes panels 19A (showing an arrangement for low or moderate wind speeds) and 19B (showing an arrangement for high winds). Both panels can be viewed as either vertical or horizontal cross-sectional depictions of a spinnaker sail 370, comprising a “main body” 372 in the center of the sail, surrounded by a movable outer segment 374, which can be called a skirt, apron, ring, rim, brim, bonnet, or similar terms. For optimal performance, unless testing indicates otherwise for one or more types of spinnaker sails having some particular design(s), or for a class of sails designed to operate at high wind speeds, the movable outer segment 374 generally should provide a continuous outer ring around the entire main body of a spinnaker sail.

The basic operating principle for such a movable outer segment 374 can be summarized as follows:

(1) when wind speeds are low or moderate, the movable outer segment 374 will be opened, as shown in panel 19A, so that it will act to expand the projected area (and pulling force) of the spinnaker sail assembly 370; and,

(2) as shown in panel 19B, when wind speeds are high, the movable outer segment 374 can be pulled into a partially closed position, to create a protective structure on the upwind side of the sail 370, which will both: (i) reduce the projected area of the sail; and, (ii) create a sloped deflector surface, which will deflect some portion of the high winds away from the main body 372 of sail 370.

Finally, it should be noted that even during exceptionally high wind speeds, including speeds that would rip apart any conventional sail made of any known type of fabric, spinnaker sails having a different type of design and construction can be deployed, in ways that will generate very large amounts of usable pulling power. That capacity arises from a type of sail called “webbing sails”, or simply “web sails”, described in the next section.

### Webbing (or Web) Sails

As defined herein, a “webbing sail” (also called a “web sail”, for convenience) is a sail which: (i) is sized and designed to render it suited for airborne use to convert wind power into mechanical force; and, (ii) is constructed by weaving and securing together a plurality of straps, while leaving rows of open spaces between adjacent straps.

Since high-wind spinnaker sails of this type will be best suited for large installations, designed for electric utilities and large factories, they are limited to sizes and designs that are intended to avoid cargo nets as prior art. In general, most sails which will be suited for electric power generation will have projected areas of at least about 2000 square feet (which corresponds to a diameter of roughly 50 feet), and in many cases are likely to be greater than 10,000 square feet (about ¼ of an acre, with a diameter of about 120 feet for a round sail). When the “area” of a web sail is being addressed, the total area bounded by the outer periphery of the sail is included, including any open spaces within the sail.

The term “open fraction” (or variants of that phrase, such as “open space fraction” or “open area fraction”) refers to the amount of open spatial area, in a segment of net that has been stretched to a moderately tight level in all directions, divided by the total area of that segment. That fraction can be converted into an “open percentage” (or “open space percentage”, etc.) by multiplying it by 100 (for example, an open space fraction of ¼ is equivalent to an open space percentage of 25%).

A web sail, as defined above, can be designed and assembled (or fabricated, etc.) to have any desired open space percentage, by the simple and straightforward procedure of: (i) selecting straps having desired widths; (ii) spacing adjacent straps a selected and controlled distance apart from each other, while they are being woven together; and (iii) affixing the straps to each other, at the intersections where they cross, by means such as stitching, rivets, staples, etc.

This principle is illustrated in FIGS. 20 and 21, which show partial segments of two different web sails, having different open space percentages. FIG. 20 illustrates web sail 380, made by interlacing vertical strap segments 382 with horizontal strap segments 384, in a simple and conventional “square weave” pattern (which can also be called a “warp-and-woof” pattern, where vertical straps 382 can be called warp strands, while horizontal straps 382 can be called woof strands). All straps are made of a suitable high-strength polymer (such as nylon, aramids, ultra-high-molecular-weight polyethylene (UHMWPE), etc.).

It also is anticipated that most such airborne web sails will be made of straps having widths of at least about 2 inches (about 5 cm), and in most cases will be made of straps having widths that are likely to range between about 3 inches (about 8 cm), up to about 12 inches (about 30 cm).

If desired, warp strands 382 can be made from a fixed type and size of strap material, while woof strands 384 are made of a different size and/or type of strap material. Similarly, some of the warp and/or woof straps can be made from relatively low-cost materials, such as nylon, while other straps are made from more expensive high-performance materials, such as aramids or UHMWPE.

Any efforts of that nature will need to take into account the different levels of “stretchability” of different types of straps; in extreme cases, that could lead to a situation where most or essentially all of the forces and stresses being imposed on a webbing would be imposed on those straps which stretch the least, with relatively little assistance or support from the straps which stretch more. Accordingly, if two different types of strap material are used, to reduce costs while providing extremely high levels of strength, a presumption arises that all of the straps going in one direction (such as the warp direction) should be made of one type of fiber (such as more expensive super-strong fibers, such as aramid or UHMWPE fibers), while all of the straps going in the other direction (such as the woof direction) should be made of less expensive fibers, such as nylon. That approach is believed (and is asserted by the Applicant herein) to be able to provide extremely strong web sails (or reinforcing strap arrays for conventional sails), at substantially lower cost than would be required for web sails or reinforcing arrays made entirely of the more expensive super-strength polymers.

Web sail 380 also depicts a border or edge device 386, which is clearly embossed, printed, or otherwise marked with a label indicating the percentage of open space in that sail. An operator who is choosing a suitable sail, based on a known or forecasted wind speed at an elevated altitude, should have several different web sails available for use. Sails which have higher levels of open space will be better suited for handling exceptionally high wind speeds.

For purposes of discussion, and to provide a practical comparison between web sails 380 (in FIG. 20) and 390 (in FIG. 21, made of vertical straps 392 and horizontal straps 394), it can be assumed that straps 382 in FIG. 20 have widths of 2 inches (5 cm), while straps 392 in FIG. 21 have widths of 3 inches (7.6 cm), while their “center-to-center” spacings (i.e., the distance between adjacent straps, as measured from the centerline of one strap, to the centerline of an adjacent strap) are identical. As can be seen in the drawings, if the wider straps are chosen while “center-to-center” spacings are kept constant, there will be smaller gaps between adjacent straps. As a result, web sail 380, in FIG. 20, made from thinner and smaller straps, will have a larger “open space percentage” (measured and calculated at approximately 45%, in web sail 380) than web sail 390 in FIG. 21 (measured and calculated at approximately 25% open space, as labeled on edge device 396).

FIG. 21 also indicates a conventional stitching pattern 398, used to affix horizontal and vertical straps to each other at the intersections where they cross. This stitch pattern has an “X” (i.e., two corner-to-corner diagonal stitchings) inside a square. Since the straps themselves will be interwoven with each other, these stitchings are not required to provide high levels of strength, to the overall material of the sail; instead, they prevent sliding motions and “creep” by the straps, which could lead to the straps migrating to high-density areas, in ways that would create low-density weak spots elsewhere in the webbing.

A web sail with a very low open space percentage, such as about 5% or less, can be created by packing relatively wide straps very close together; however, a “sail” made in that manner would be much heavier, and much more expensive, than other types of heavily reinforced sails that could be created by other methods. At the other extreme, a web sail with a very high open space percentage, such as 90% or more, can be created by assembling thin straps that are spaced far apart from each other; however, that type of net would not be well-suited for use as a power-generating airborne spinnaker sail.

Accordingly, unless and until testing indicates otherwise, it is asserted by the Applicant herein that an assortment of web nets having open space percentages ranging from about 10 percent, up to about 70 percent, can provide power station operators with a useful assortment of web sails (in additional to conventional reinforced “standard” sails) that can be used to generate electric power over a very broad range of wind speeds, including winds that may reach or even exceed 150 miles per hour, which occur fairly often at elevated altitudes. The most similar types of nets or assemblies known to the Applicant herein, at this time, are usually called “cargo lifting nets”, or simply “cargo nets”. Since they can be assembled without difficulty, once the straps are available, they are available from nearly any company that sells straps made from nylon, polyethylene, polypropylene, and/or polyaramid, and they can be custom-fabricated, using any dimensions and specifications that a purchaser provides to a supplier. Photographs of a cargo-lifting net, made from nylon straps having a “square weave” pattern with an open space percentage estimated to be about 90%, are available on the website of U.S. Netting, at www.usnetting.com/html/cargolift.html. An essentially identical but smaller net, sized to cover the bed of a pickup truck (to secure any cargo the truck is carrying) is illustrated at www.cargogear.com/oneiteminfo.aspx?partnum=BNNETFSB. Neither of those cargo nets would be suited for use as a web sail as described herein, since their “open space percentage” (about 90 to 95%, for each of them) is too high to allow them to function effectively as an airborne sail that can generate very high levels of pulling power, by capturing wind. However, they illustrate the type of assembly that could be adapted for use as a “web sail”, if their open space percentages were lower.

It also is disclosed herein that web sails can have different structural components, in different portions of a sail. For example, a round sail which will assume a domed shape comparable to a parachute, when deployed, can have a reinforcing web made of woven straps, behind the entire sail. The outer portion of the circular sail, extending from the outer rim to some percentage of the distance along the radial straps (which could range from about 30% to about 70% of the distance from the outer rim to the center, for sails designed for use in various different wind conditions) can be covered, on the upwind side, with a woven sheet of Dacron or similar polymeric fabric, since that outer ring portion will not bear the “full brunt” of the wind pressure, due to its sharply angled orientation around the periphery of the dome-shaped sail. The inner region of the sail can be made of an open web, with no sailcloth fabric covering it, to enable it to handle the highest and most concentrated pressures and stresses.

It also is possible to provide movable sailcloth segments on the upwind side of a sail webbing that is made of straps. This would allow a single relatively expensive webbing to be used over a wider variety of wind conditions, with optimal or near-optimal performance over a wide range of conditions (i.e., segments of sailcloth could be used to cover up the open spaces in certain areas, during low or moderate winds, and the sailcloth can be pulled back from those areas, in high winds). In such sails, any such movement of sailcloth fabric, across the surface of a webbing, preferably should be done during a retrieval stage, when there will be little or no force imposed on the sailcloth segments, rather than during a pulling stage.

Accordingly, when described in terms suited for a patent claim, the web sails disclosed herein are devices for generating wind-driven pulling force at levels sufficient to drive electric power generation, comprising a net assembly having a shape and size that enable the net assembly to function as an airborne spinnaker sail at elevated altitudes, wherein:

a. at least a portion of said net assembly comprises interwoven straps made from polymeric fibers, wherein said straps are spaced apart from each other by controlled distances which will cause said net assembly to have an open space percentage of at least about 10 percent but not exceeding about 70 percent; and,

b. said net assembly is bounded by a peripheral structure which enables a plurality of cables to be securely attached to said net assembly,

and wherein said device has a vertically-planar projected area of at least 1000 square feet when deployed in a horizontal wind,

and wherein said net assembly is designed to withstand wind speeds of at least 100 miles per hour without damage or deterioration.

Furthermore, in most of the embodiments that will be preferred for use as disclosed herein, the straps used to make such a sail will have widths of at least about 2 inches; and, if a web sail having a circular shape is used, it will need to be designed to generate a dome-shaped structure, when the web sail is deployed, to give it greater stability in high winds. In such a dome shape, the “horizontal displacement” of the dome (i.e., the distance between the center point, and an imaginary vertical plane which is aligned with the outer rim of the dome) is likely to be at least about 15 percent of the diameter of the deployed circular shape.

It is believed that these types of airborne “web sails” are patentable in their own right, and there was no disclosure or suggestion of any such sails in the above-cited parent application Ser. No. 12/390,503. Accordingly, a separate patent application is being filed simultaneously herewith, with claims that address “web sails” made of interwoven straps with gaps between them, for use in generating electric power during high winds. That application is not a continuation-in-part of the æ503 application; instead, its priority date is its filing date.

### Electronic Monitoring and Control Systems

The types of monitoring and control systems that will be incorporated into power-generating installations as described herein can vary, and can be custom-tailored to suit the size, cost, and complexity of any installation (which will include both the airborne components, and the ground station). Once the hardware and software components of a new type of computerized control system have been designed, debugged, and commercialized, the per-unit “marginal” costs of making additional copies are very low. Accordingly, it is likely that even relatively modest pulling systems will be provided with electronic measuring, monitoring, and reporting systems that will be able to measure, record, and report each of the factors or parameters listed below, at all times during every power cycle. Any parameter listed below can be measured and recorded at any desired frequency (such as once every second, or once every 10, 30, or 60 seconds); if early testing indicates that less frequent measurements will be adequate during routine operations, the monitoring interval for any parameter can be lengthened when routine weather conditions are occurring. If desired, the control system can be programmed to switch back to more frequent monitoring, during high winds or storm conditions, or whenever any type of upset or non-routine variance has been detected.

Unless and until early operations indicate that fewer variables can be measured without impairing effective control and safe operation at some particular installation, each and all of the following parameters can be monitored and recorded at any desired interval or frequency:

(1) the location of an airbarge, as a function of time, during each power cycle. Location can be measured in “absolute” terms (i.e., relative to non-moving landmarks), by using a global positioning satellite (GPS) system, radar-type signals from a fixed ground unit, or similar means, and in “relative” terms by measuring the amount of cable that has been released from a drum or winch during a pulling stage, and recovered during a retrieval stage.

(2) the nose-to-tail flying angle (i.e., the “pitch” or “trim”) of an airbarge, during each power cycle;

(3) any unwanted or unexpected linear or rotational motion along or around the vertical, longitudinal, or transverse “axes” of an airbarge (as mentioned in the Background section, unwanted rotational motions include yaw, roll, and pitch; unwanted linear (translational) motions include heave, surge, and sway);

(4) “apparent” (i.e., gauge-measured) wind speeds (including gust speeds) and directions;

(5) the amount of tensile force that is being applied to each important cable, strap, chain, or other tensile member, at any time during a power cycle; and,

(6) the relative positions of any control mechanisms (such as the position, along the longitudinal axis, of a transverse axle 256 as shown in FIG. 6, and the angular positions of any movable fins, flaps, or other control mechanisms), during each stage of a power cycle.

The readings and measurements from any sensors on an airbarge can be sent (via “hard-wired”, radiofrequency, or similar signals), to one or more computerized control systems on board the airbarge. In most cases, the onboard control system will use a microprocessor unit, which will be programmed to run software that was written specifically for that particular control system. Depending on the cost of an installation, an operator can choose to have a second on-board control system ready and waiting at all times, in case the primary system fails.

A typical onboard control system which uses a microprocessor can be regarded as having four levels (or subassemblies, etc.), which can be summarized as:

(1) a set of sensors, which will be measuring devices that gather information concerning the system (such as wind speed, the pitch or trim of the airbarge, the tensile forces on various cables or other components, etc.). The sensor units include any components which enable the sensors to provide the information gathered by the sensors, to a centralized onboard control unit;

(2) a microprocessor or similar computerized processing system, which will gather and process the incoming data from the sensors, and which also will include an “output port”, which typically will be attached to a multi-lead cable or transmitting system which will send out signals that will be used to control the “actuators”, described below;

(3) software, which includes the instructions that tell the onboard microprocessor or computer how to handle and respond to the incoming data at any given moment, and how to send out signals to the actuators that will control the system; and,

(4) a set of “actuators”, which includes the switches, motors, gears, fins, flaps, and other movable devices that are locations at various sites distributed around an airbarge or sail, which will convert signals from a microprocessor or computer, into physical equipment alterations (such as rotation of a fin, retraction or extension of a cable, travel of any cable-attachment axle or devices toward the nose or tail end, etc.) that will be used to “fly” an airbarge-and-sail system through the pulling and retrieval stages of each power cycle.

Since computerized control systems enable faster and more powerful, sophisticated, and adaptive control over nearly any type of machinery, equipment, or installation that is subject to fluctuations, process disruptions, changes in inputs and supplies, changes in environmental parameters, or changes in customer or user demands, a large and well-developed skill-base has arisen, of computer programmers who write software for microprocessors and computers that are used to control such systems. The ability to create these types of computerized control systems, and the software used to run them, is well within the skill in that field of art, once the details of a hardware system (including the sensor devices and actuators), and the design and operating parameters of the system, are known.

In addition, an on-board computerized control system can receive GPS signals, as well as signals from a ground station, indicating how far a pulling assembly has traveled from the ground station (and, if desired, how much tethering cable has been “unreeled” from a set of generators, how far up the tracks a train-and-generator unit has been pulled, etc.). Accordingly, the on-board control system can determine where the system stands, with respect to a pulling or retrieval stage, at any moment in time.

In a system of this type, an on-board microprocessor can be programmed to take all steps necessary to control the system at all times, while sending out “telemetry” signals to a ground station. At the ground station, human operators and a more complex and sophisticated control system will be able to monitor the status, and the operating and environmental parameters, of the system at all times. The entire system can be designed to give human operators and/or the ground control system the ability to override the onboard control system at any time, to enable the operators and/or ground system to establish direct control over any flying units. Various types of alerts and alarms are typically programmed into a control system of this type, to draw attention to any condition or parameter which is at risk of veering outside of a normal and tolerable range of variations, during any particular stage of a power cycle.

In addition, the operators of the control system (or the control system itself) can be kept informed of weather conditions that are occurring at various distances located “upwind” of the system, so that they will have an hour or more advance notice if a storm or unusual weather condition is approaching. Similarly, an on-board system can be programmed to transfer any stored data to a ground computer or control system, both at regular intervals (such as after each power cycle, when a retrieval stage has been completed and a new pulling stage is about to commence), and whenever instructed to do so by a manual command from the ground station.

The control system also can be programmed to take the system into a safety, shutdown, or other protective mode, if power or communications are lost for more than a predetermined period of time. These types of safety, shutdown, or protective operations can involve, for example, one or more of:

(1) a landing or mooring operation;

(2) partial deflation of an airbarge, by pumping at least a portion of the buoyant gas into high-pressure tanks;

(3) fully or partially furling a spinnaker sail (i.e., winding it onto an elongated spool that will protect it);

(4) release of the spinnaker sail from the airbarge, with sufficient weight attached to the sail to cause it to descend to the ground, in parachute mode;

(4) ascent to an altitude higher than any storm clouds;

(5) release of a grappling cable that will hang vertically beneath an airbarge, to enable a drone, helicopter, or other aircraft to establish towing control over the airbarge; and/or,

(6) any other steps that would reduce the risk of damage to the system, depending on its size, design, and local environment.

Finally, it should be mentioned that any onboard control devices that involve computers, or which require power to drive any type of equipment alteration (such as retraction and tightening of a cable, power-driven travel of a transverse axle, etc.), will require sufficient electric power, or other power, to drive any such devices. Electric power can be provided by any of several means. For example, as mentioned above, a set of solar-powered photovoltaic panels can be mounted on the upper surface of an airbarge, and electric current generated by those panels can be sent to a set of batteries or fuel cells that can store electric power until needed. Alternately, if a set of propeller engines is mounted around the periphery of an airbarge, as illustrated in FIG. 14, the engines can be designed to function as wind-driven turbines that will generate electric power which can be used to drive any onboard devices.

### Altering the External Shape of an Airbarge

As mentioned above, a “kite-manta-wing” (KMW) airbarge can be provided with mechanisms that can be used to alter the external shape of the airbarge. This can allow its shape to be shifted back and forth, in a cyclic manner, between two or more different shapes (or “modes”), to optimize its performance during the different stages of a power cycle.

As a general principle, if a large curvilinear surface on a flying device can be controlled in a manner which presents a concave “scoop”-type shape (or a specific flow channel, bounded by walls or barriers on both sides) to an oncoming wind, the concave “scoop” or flow channel can maximize the ability of the device to utilize the force that is being offered to it, by the wind. This is comparable to saying that water will flow more rapidly and efficiently through a sunken flow channel, having a fixed and efficient cross-section, compared to simply allowing water to flow downward across a wide and flat surface which has a slight slope to it.

Accordingly, unless testing indicates that some other design would be preferable, reciprocating systems can be provided which will alter the external shape of an airbarge, in a cyclic manner, to maximize performance and efficiency during the pulling and retrieval stages of a power cycle. This can be done by shifting the concave surface or flow channel (which will be aligned in the nose-to-tail direction) back and forth, in a reciprocating manner, between: (i) the bottom surface of the airbarge or kite, to help generate lifting force during the pulling stage of each power cycle; and, (ii) the top surface of a buoyant airbarge, to counteract and offset the buoyant force of the hydrogen and/or helium gas during each retrieval stage.

To a large extent, any force and power that will be required to drive that type of shape alteration can be provided (at no cost) by wind, as indicated in FIG. 9, discussed above. However, if testing indicates that the use of additional mechanical means to modify the shape of an airbarge can: (i) increase the efficiency and/or power output of an airbarge-and-sail system, and/or (ii) help an airbarge handle any transitional states that will arise when it is shifting back and forth between pulling and retrieval modes, then the types of mechanisms described below will merit consideration.

One mechanism for increasing and enhancing a “flow channel” shape, which can be shifted back and forth between the top and bottom surfaces of an airbarge, is illustrated in FIG. 22, which includes panels 22A and 22B. Both panels offer an elevation (vertical) view, seen from the tail end of an airbarge 650 which is filled with hydrogen or helium gas, and which has bottom surface 652 (which will be “presented to” the wind, when airbarge 650 is flying in a “nose up” angle during a pulling stage), and a top surface 654 (which will be pressed against, by the wind, when airbarge 650 is flying in a nose down angle, during a retrieval stage).

Airbarge 650 has two vertical outer (or side) fins 662 and 664, which preferably should extend along the entire length of the airbarge (as indicated by similar outer side fins 602 and 604, shown in perspective view in FIG. 15). It also has a vertical center fin 666.

In FIG. 22, each of side fins 652 and 654 has a movable vertical panel 669 affixed to it, via a rail system or similar means which will allow the vertical panel 669 to be moved upward or downward. During each pulling stage, as shown in FIG. 22A, the two vertical panels 669 will be moved downward. This will increase and enhance the “flow channel” shape that will be created on the bottom surface 652 of airbarge 650, during each pulling stage. That “flow channel” shape (which will be further increased and enhanced by the concave curvature of flexible bottom surface 652, caused by pressure from the wind as it passes beneath against the airbarge when it is flying in a “nose up” angle) will help generate and sustain increased lifting and pulling force, which can be translated into increased electric power output by the complete system.

Conversely, during each retrieval stage, as shown in FIG. 22B, the two vertical panels 669 will be moved upward. This will increase and enhance the “flow channel” shape that is created on the top surface 654 of airbarge 650, during each retrieval stage. The enhanced wind pressure, when applied to the top surface of a buoyant airbarge that is filled with hydrogen or helium gas, can help drive the airbarge lower, to a desired “starting point” altitude that will enable the next power cycle to commence. This can enable each retrieval operation to be carried out, with lower energy consumption requirements.

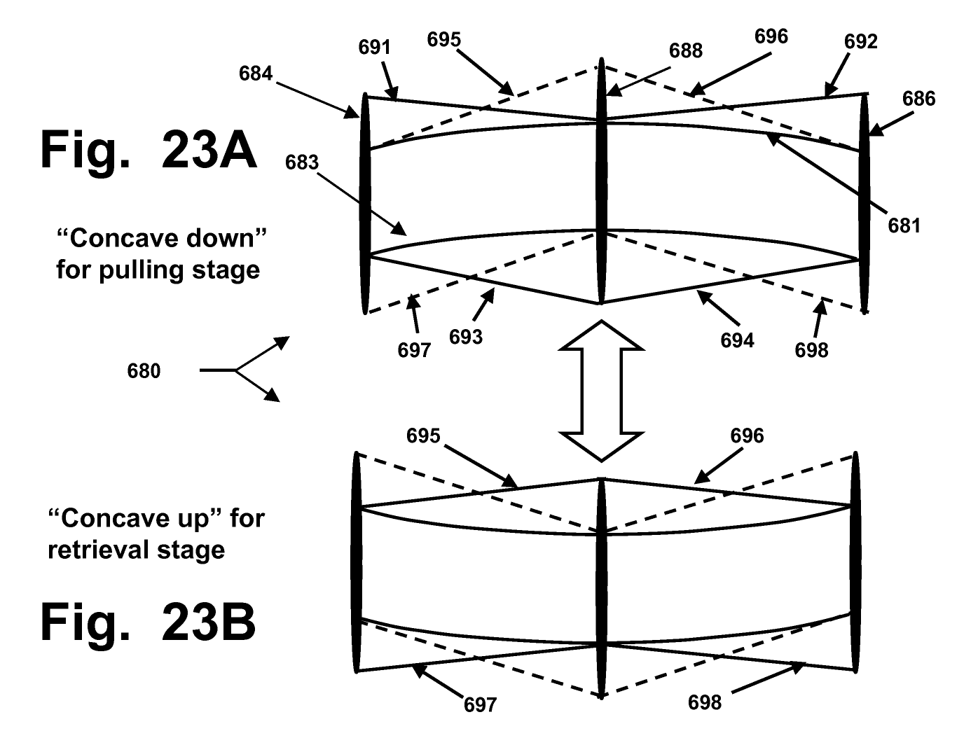

Alternately or additionally, an airbarge can utilize cables that are attached to a series of reinforced sites positioned along the tips and bases of any vertical fins, to provide mechanical means for controlling the external shape of the airbarge. For example, FIG. 23 (which includes panels 23A and 23B, both of which are elevation views from the tail end), depicts airbarge 680, which has upper surface 681, lower surface 683, outer fins 684 and 686, and center fin 688. A series of parallel left cables 691, and parallel right cables 692, are affixed to a series of reinforced attachment devices mounted along: (i) the top edges of the side fins 684 and 686; and (ii) the top-side base of center fin 688. Therefore, when top-side cables 691 and 692 are pulled tight, and are held in tension, they will pull the base of center fin 686 upward, thereby helping to create a convex shape on top surface 681.

Similarly, a series of parallel left cables 693 and parallel right cables 694 are affixed to a series of reinforced attachment devices mounted along: (i) the bottom-side bases of side fins 684 and 686, and (ii) the bottom edge of center fin 688. Therefore, when bottom-side cables 693 and 694 are pulled tight and held in tension, they will pull the center fin 686 upward, thereby helping to create a concave shape on bottom surface 683.

The four sets of cables 691-694 which are in tension, during a pulling stage, are depicted by solid lines in panel 23A. By contrast, top-side cables 695 and 696 (attached to the reinforced attachment sites along the bases of side fins 684 and 686, and along the top edge of center fin 688), and the bottom-side cables 697 and 698 (attached to the bottom edged of the side fins, and the bottom base of the center fin), will be relaxed, and will not be exerting tension during a pulling stage. Accordingly, those two sets of cables 695 and 696 are represented by dotted lines in panel 23A. Similarly, bottom-side cable sets 697 and 698 also will be relaxed during a pulling stage, so they also are depicted by dotted lines, in panel 23A.

To reverse the shape of airbarge 680 and turn it into a “concave up” shape for a retrieval stage of a power cycle, the status of all eight of the cable sets is reversed, as depicted in panel 23B. Each of cable sets 695-698 will be placed under tension, and those forces will pull the center fin 688 downward, relative to the side fins. In addition, the tension on cable sets 691-694 (depicted by dotted lines in panel 23B) will be released and relaxed.

Those principles and arrangements are depicted in a “mild and moderate” fashion in FIG. 23. In practice, these and other cable arrangements can enable far greater levels of flexure, such as to a point of creating a “half-pipe” scoop shape, as depicted for the hybridized airbarge-kite 560 in FIG. 13.

In addition, if a relatively wide and thin airbarge is made of longitudinal segments, connected to each other by hinge-type devices (which can be mechanical hinges, relatively narrow and thin inflated segments between larger and thicker inflated segments, etc.), wind pressure on the bottom surface, during a pulling cycle, can convert a transverse cross-sectional shape into an arc or semi-circle, with its concave shape on the bottom, without requiring any additional cables of the type shown in FIG. 23; instead, any such cables or reinforcing straps could be used to limit and control the curvature of the arc, so that it remains relatively round, with a large projected area that will generate large pulling forces, rather than shifting into an undesirably narrow U-shaped channel. Accordingly, the “half pipe” shape shown in FIG. 13, created by a relatively thin KMW airbarge which can flex into an arc approaching a semi-circle (and which also can include a sloped “tail end” to generate even greater lift), yet which is thick enough to contain sufficient hydrogen or helium gas to keep the airbarge-and-sail assembly airborne even in still air, merits serious consideration in any efforts to develop optimized lifting systems.

In addition to the foregoing, it also should be understood that any steps that are taken to rotate or otherwise alter the position, angle, shape, or orientation of a fin, flap, wing, or other external device on an airbarge or kite, can also be regarded as methods of altering the external shape of an airbarge or kite.

### Alternate Cable Attachments

The embodiments discussed above and illustrated in FIGS. 6-23 are compatible with an arrangement wherein an airbarge will travel away from its ground station, as the spinnaker sail effectively “tows” the airbarge in a downwind direction, during each pulling cycle; then, during each retrieval cycle, both the airbarge and the spinnaker sail will be winched or otherwise towed back to a position close to the ground station, before the next power cycle begins. This arrangement will allow a well-designed airbarge to act in conjunction with the spinnaker sail to generate greater pulling power, which can lead to greater power output for the system.

However, alternate arrangements and embodiments also are possible, such as the arrangement illustrated in FIG. 24. In this arrangement, a airbarge 700 is used to suspend a pulling-cable support device 702, at an elevated altitude, in a “semi-stationary” manner. Airbarge 700 is moored to ground anchors 710, which are mounted on a rotatable platform 712 (comparable to platform 400 in FIG. 10), or on a similar movable system (such as a circular rail system having a diameter such as 50 to 150 yards or meters), to enable the airbarge to travel horizontally, in an arc, while remaining airborne. That type of mooring system will enable the buoyant airbarge 700 to remain a fixed distance from a ground station, but with an ability to travel in a horizontal arc while remaining at an elevated altitude. This will enable the airbarge-and-sail system to rotate around an imaginary vertical axis which passes through the center of rotatable platform 712, in a manner which enables both the airbarge and the sail to position themselves directly downwind of the ground station at all times, during use, depending on which way the wind is blowing at any given moment.

Mooring cables 714 and 716, which are coupled near the fore and aft ends of airbarge 700, are adjustable but can be securely gripped and affixed at desired lengths (by a clamping mechanism, a gear or sprocket system, etc.). This type of mooring system will allow the pitch of airbarge 700 to be controlled and adjusted, depending on wind speed at any particular time, as described below.

The end of at least one active “pulling cable” 720 is wrapped around a windlass drum or spool 722, which is coupled to a rotatable shaft of an electric generator (or to a towing system for a train, as shown in FIGS. 1 and 2, or to some other suitable mechanism). The other end of active cable 720 is coupled to spinnaker sail 730, via distributed sail cables 732 and/or a spreader device such as shown in FIG. 15. Accordingly, when sail 730 is driven farther away from the ground station, by the force of the wind at an elevated altitude, the wind-driven unwinding of pulling cable 720 from the windlass drum or spool 722 drives the rotation of a generator shaft, to generate electric power.

During that pulling operation, airbarge 700, and the pulling-cable support device 702 (which is suspended beneath the airbarge 700) will remain a fixed distance away from the ground station, and pulling cable 720 will travel and pass through or across the support device 702. Steps must be taken to minimize any friction, abrasion, and gradual wearing and degradation of pulling cable 720, as it travels repeatedly through or across the stationary cable-supporting device 702, during each power cycle. That can be accomplished by means such as providing the cable-supporting device 702 with a freely-rotatable surface, such as can be provided by an axle shaft, pulley, or drum that is coated with a non-slip material (such as, for example, the type of rubber found on automobile and truck tires).

Accordingly, as indicated in FIG. 24, the airbarge 700 and pulling-cable support device 702 will effectively “lift” the pulling cable upward, to a suitable operating altitude where the winds are generally faster and more powerful than at low altitudes close to the ground. After the pulling cable has reached that altitude and has crossed the axle or pulley(s) 702, it can travel and operate in a generally horizontal direction that is aligned with the wind and therefore able to make optimal use of the wind energy that is being “harvested” by the spinnaker sail.

During each retrieval stage, the spinnaker sail is partially released, and converted into a “luffing” configuration comparable to a flag or banner, to allow it to be pulled back to its starting point with minimal resistance and power requirements. That retrieval stage can be performed with the help of a cable 704, which can couple the spinnaker sail 730 to the tail end of airbarge 700; alternately, the spinnaker sail 730 can be manipulated in any other suitable manner, to reduce and minimize its “projected area” during each retrieval stage. For example, as mentioned above, if a center cable is kept in tension while any cables around the periphery of the sail are released from tension, the sail to convert or collapse into a “closed umbrella” configuration which points upwind, to allow low-power towing of the sail back to a starting point.

When large tensile loads are imposed on pulling cable 720, as the sail is being pulled by the wind, pulling cable 720 will exert a substantial downward pulling force on a “stationary” airbarge 700. Accordingly, airbarge 700 will need to be properly sized and designed to sustain a desired operating altitude, even when the spinnaker sail is operating in high winds. To help enable that result without requiring the airbarge to be seriously “oversized”, the rearward mooring cables 712 can be retracted somewhat (and/or the forward cables 714 can be extended somewhat), when high winds are occurring or approaching. Either or both of those cable can rotate the “stationary” airbarge 700 into a slight or moderate “nose up” angle (or pitch, trim, etc.), which will allow wind pressure on the bottom surface to compensate for any increased downward pull by the spinnaker sail during the high winds. Accordingly, a “stationary” airbarge can and preferably should be sized and designed to sustain a suitable operating altitude, both for itself and for a spinnaker sail, even when the prevailing wind speed at the time is 100 miles per hour.

Methods for Converting Wind Energy into Power Output

In addition to the various devices and assemblies described and illustrated herein, this application also discloses and claims certain methods for converting wind energy, into usable power output.

When described in language suited for a patent claim, the essential aspects and steps of the overarching method described herein can be boiled down to the following steps:

a. using a buoyant gas-filled lifting device to position an airborne spinnaker sail at an elevated altitude, at a location where the airborne spinnaker sail is ready to commence a pulling stage of a repeatable power cycle. In addition, to render the system capable of practical operation, the airborne spinnaker sail must be coupled to an airborne segment of at least one tensile member or assembly; and, the tensile member or assembly must also have a ground-anchored segment, which must be coupled to an electromechanical system that will indeed convert the sail-driven travel, of the tensile member or assembly, into usable power output (such as electric power);

b. enabling the airborne spinnaker sail to travel a limited horizontal distance, while driven (the technical term is “motivated”, which refers not to mental or psychological factors, but to the type of positional changes and travel that are encompassed within the related words “motion” and “move”) by wind energy, during which time the wind-driven spinnaker sail will also be pulling and towing the airborne segment of the tensile member or assembly;

c. using the wind-driven pulling force and travel of the airborne segment of the tensile member or assembly, to drive a power-generating activity of the power-conversion device at the ground station (such as by driving the rotation of a generator shaft, by towing a heavy train-and-generator unit up a sloping or vertical rail track, etc.).

In some of the embodiments of that method, as illustrated in FIGS. 6-23, the airbarge will travel horizontally, along with the wind-driven spinnaker sail. In an alternate embodiment, as illustrated in FIG. 24, the airbarge will be moored to the ground station, and the spinnaker sail will travel horizontally while the pulling cable attached to it passes through a cable support device suspended beneath the airbarge.

Thus, there has been shown and described a new and useful system for converting wind energy, into electric power. Although this invention has been exemplified for purposes of illustration and description by reference to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

1. A device for generating wind-driven pulling force at levels sufficient to drive electric power generation, comprising a net assembly having a shape and size that enable the net assembly to function as an airborne spinnaker sail at elevated altitudes, wherein:
a. at least a portion of said net assembly comprises interwoven straps made from polymeric fibers, wherein said straps are spaced apart from each other by controlled distances which will cause said net assembly to have an open space percentage of at least about 10 percent but not exceeding about 70 percent; and,
b. said net assembly is bounded by a peripheral structure which enables a plurality of cables to be securely attached to said net assembly,
and wherein said device has a vertically-planar projected area of at least 1000 square feet when deployed in a horizontal wind,
and wherein said net assembly is designed to withstand wind speeds of at least 100 miles per hour without damage or deterioration.

2. The device of claim 1, wherein said straps have widths of at least about 2 inches each.

3. The device of claim 1, wherein said net assembly has a vertically-planar projected area with a circular shape and a center point, and wherein said net assembly generates a dome-shaped structure when filled with wind, wherein said center point in said dome has a horizontal displacement of at least about 15 percent of the diameter of the circular shape.
